(19) United States
(12) Patent Application Publication
(10) Pub. No.: US 2025/0105482 A1
(43) Pub. Date: Mar. 27, 2025

(54) E-PLANE CERAMIC WAVEGUIDE FILTER

(71) Applicant: CACI, INC.- FEDERAL, Reston, VA (US)

(72) Inventor: Scott W. BURGESS, Albuquerque, NM (US)

(21) Appl. No.: 18/472,548

(22) Filed: Sep. 22, 2023

(51) Int. Cl. H01P 1/20; H01P 1/02; H01P 7/10

(52) U.S. Cl. CPC H01P 1/2002; H01P 1/025; H01P 7/10

(57) ABSTRACT

E-plane waveguide filters, and methods for manufacturing the same, are described herein. In one aspect, a filter may include a first dielectric block (e.g., including a first coupling structure) and a second dielectric block (e.g., including a second coupling structure). A septum may be formed by a union of the first coupling structure and the second coupling structure, e.g., eliminating the need for a separate septum. Moreover, one or more of resonators, a metalized septum for inter-resonator couplings, and/or various input and output couplings loops or probes for input loading into the filter may be pressed, machined, lased, or screen printed onto\into the blocks. By reducing the part count of the E-plane filter and/or decreasing its complexity, the structure of the E-plane filter may be manufactured for efficiently and its cost may be decreased.

### FIELD

The present disclosure is generally related to ceramic filters, and more particularly, to structures of an E-plane ceramic waveguide filter including a plurality of coupled blocks that form one or more resonators and one or more coupling windows.

### BACKGROUND

Filters are electronic devices that allow for the transmission of electromagnetic waves. Filters are typically designed to permit one or more frequencies to pass through the filter, and to substantially prevent other frequencies from passing through the filter.

In an example, a base station for a mobile communication system and microwave radio links used for data transport may include a plurality of transceivers connected to an antenna for transmitting and receiving microwave signals. Each transceiver may include a diplexer/duplexer comprising of at least two band-pass filters. The filters of the diplexer may have different passbands, e.g., to prevent intermodulation between a transmission signal and a received signal.

Microwave filters (e.g., transmission line filters) often include a microstrip arranged on a dielectric carrier. Hollow waveguides are also often used as filters due to, as compared to microstrips, lower associated losses and higher associated power capabilities. However, hollow waveguide filters often have larger surface areas than microstrip filters.

Ceramic waveguide filters are particularly beneficial hollow waveguide filter types due to their small size and weight. Ceramic waveguide filters may include a block of ceramic having high permittivity and low loss characteristics, with a design to achieve particular frequency attenuation and propagation.

The dimensions of a hollow waveguide filter are dependent on one or more of a frequency of the signal to be filtered, selected filtering properties (e.g., a certain passband), and type of filter. Since the size of the waveguide must be on the same order as the wavelength of the frequency of the signal that is to be filtered, hollow waveguides are typically used for frequencies in the GHz range which have wavelengths in the mm range.

In some applications, such as in outdoor microwave radio or radio base station units, selecting a type of filter may be dependent on one or more of size limitations, weight, available space, and/or power handling. For example, in many military and commercial applications (e.g., mini-cell repeaters, drones, airplanes) selecting a type of filter may be dependent on one or more factors, including size, weight, and power handling (“SWaP”). Accordingly, it may be desirable to reduce the size of a filter without significantly degrading the frequency and power handling properties of the filter. Waveguide E-plane filters may be an attractive choice due to footprint size and weight reduction, and high-power handling for the size.

Conventional E-plane filters are typically designed with a metallic septum (e.g., conductive foil or insert) sandwiched between one or more air cavities. The septum may be arranged in the waveguide filter at or close to the location where the strength of the E-field (V/m) is the highest. The septum may include periodic windows (e.g., apertures) which act as resonators, thereby determining the poles of the filter, and consequently may also contribute to determining the passband of the filter. In some E-filter designs, rather than utilizing a metal septum, the septum and window structures are etched on a circuit board. E-plane filters of this type typically require at least 3 parts to manufacture, e.g., two housings and one septum. Moreover, E-plane filters of this type are typically costly and complex to manufacture.

In order to simplify the structure of the E-plane filter, decrease its cost (e.g., increase production yields and control production costs), and minimize necessary tuning, there is a need to reduce the part count of the E-plane filter and/or decrease the complexity of the E-plane filter.

### SUMMARY

The foregoing needs are met, to a great extent, by the invention directed to an E-plane ceramic waveguide filter. Size and weight of a radiofrequency (RF) filter may be significantly reduced by dielectrically loading the RF filter, thereby satisfying critical design parameters (e.g., SWaP). Applications where SWaP is desirable may include environments where signal communication may be interrupted due to reduced signal propagation range, such as subways, mines, and mobile transportation (e.g., dropped-call areas). Other applications where SWaP may be desirable may include applications where weight is a concern, such as mobile military communications (e.g., reducing weight burden on soldiers) and flight applications (e.g., airplanes and drones), and/or a combination of both. Moreover, E-plane waveguide filters as set forth herein may provide an RF filter with one or more additional advantages (e.g., properties that correlate to higher power handling for a filter size), including high voltage breakdown properties (e.g., relative to air), low temperature frequency drift, and may operate at very high temperatures.

E-plane waveguide filters and methods for manufacturing the same are described herein. The architecture may include a plurality of coupled metalized dielectric blocks, where the coupling structures are pressed, machined, lased, or screen printed onto\into the blocks and then attached to create the RF E-plane waveguide filter. In an embodiment, an RF waveguide may be formed by coupling a plurality of metalized dielectric blocks. Resonators, a metalized septum for inter-resonator couplings, and/or various input and output couplings loops or probes for the input loading into the filter may be pressed, machined, lased, or screen printed onto\into the blocks, e.g., eliminating the need for a separate septum.

For example, a waveguide may be divided in half along the waveguide's narrow wall into two long blocks, the two long blocks may be plated, and a pattern may be created on each block. Moreover, pattern artwork may couple the electric field through periodic open windows (e.g., creating the filter's resonators) and metalized septa between the windows. The metalized septa may create inductive couplings between each resonator pair. A surface mount, loop, and/or probe input coupling may be incorporated into the pattern artwork to create either capacitive or inductive input and output couplings (e.g., loading) into the filter. The ceramic blocks may be reassembled to create the E-plane waveguide filter.

In one aspect, an E-plane waveguide filter may include a dielectric body including a first dielectric block and a second dielectric block. The first dielectric block may define a first longitudinal surface, a second longitudinal surface, a top surface, a first end face, and a second end face. The second dielectric block may define a first longitudinal surface, a second longitudinal surface, a top surface, a first end face, and a second end face. The first dielectric block and the second dielectric block may be coupled via respective first longitudinal surfaces.

In some aspects, a third dielectric block may define a first longitudinal surface, a second longitudinal surface, a top surface, a first end face, and a second end face. The first longitudinal surface or the second longitudinal surface of the third dielectric block may be coupled to the respective end faces of the first dielectric block and the second dielectric block.

In some aspects, the third dielectric block may intersect the coupled first dielectric block and the second dielectric block. For example, the third dielectric block may be a rectangular waveguide and may include a window coupling at each of one or more intersections of the third dielectric block and the first dielectric block and/or the third dielectric block and the second dielectric block.

There has thus been outlined, rather broadly, certain aspects in order that the detailed description thereof herein may be better understood, and in order that the present contribution to the art may be appreciated. There are, of course, additional aspects that the disclosure provided herein will describe below and which will for the subject matter of the claims hereto.

### BRIEF DESCRIPTION OF THE DRAWINGS

In order to facilitate a fuller understanding of the invention, reference is now made to the accompanying drawings, in which like elements are referenced with like numerals. These drawings should not be construed as limiting the invention and intended only to be illustrative.

FIG. 1A illustrates an E-plane waveguide filter according to the present disclosure.

FIG. 1B illustrates an E-plane waveguide filter according to the present disclosure.

FIG. 2 depicts a frequency response graph for an E-plane waveguide filter according to the present disclosure.

FIG. 3A illustrates an E-plane waveguide filter according to the present disclosure.

FIG. 3B illustrates an E-plane waveguide filter according to the present disclosure.

FIG. 4A illustrates an E-plane waveguide filter according to the present disclosure.

FIG. 4B illustrates an E-plane waveguide filter according to the present disclosure.

FIG. 4C illustrates an E-plane waveguide filter according to the present disclosure.

FIG. 4D illustrates an E-plane waveguide filter according to the present disclosure.

FIG. 5A illustrates an E-plane waveguide filter according to the present disclosure.

FIG. 5B illustrates an E-plane waveguide filter according to the present disclosure.

FIG. 6 illustrates an E-plane waveguide filter according to the present disclosure.

FIG. 7A illustrates an E-plane waveguide filter according to the present disclosure.

FIG. 7B illustrates an E-plane waveguide filter according to the present disclosure.

FIG. 7C illustrates an E-plane waveguide filter according to the present disclosure.

FIG. 7D depicts a frequency response graph for an E-plane waveguide filter according to the present disclosure.

FIG. 7E1 depicts a coupling model according to the present disclosure.

FIG. 7E2 depicts an E-plane waveguide filter according to the present disclosure.

FIG. 7E3 depicts a frequency response graph according to the present disclosure.

FIG. 7E4 depicts an E-plane waveguide filter according to the present disclosure.

FIG. 7E5 depicts a frequency response graph according to the present disclosure.

FIG. 8 depicts a frequency response graph for an E-plane waveguide filter according to the present disclosure.

FIG. 9A illustrates an E-plane waveguide filter according to the present disclosure.

FIG. 9B illustrates an E-plane waveguide filter according to the present disclosure.

FIG. 9C illustrates an E-plane waveguide filter according to the present disclosure.

FIG. 9D depicts a frequency response graph for an E-plane waveguide filter according to the present disclosure.

FIG. 9E1 depicts an E-plane waveguide filter according to the present disclosure.

FIG. 9E2 depicts a coupling model according to the present disclosure.

FIG. 9E3 depicts a frequency response graph according to the present disclosure.

FIG. 9E4 depicts an E-plane waveguide filter according to the present disclosure.

FIG. 9E5 depicts a coupling model according to the present disclosure.

FIG. 9E6 depicts a frequency response graph according to the present disclosure.

FIG. 9E7 depicts an E-plane waveguide filter according to the present disclosure.

FIG. 9E8 depicts a coupling model according to the present disclosure.

FIG. 9E9 depicts a frequency response graph according to the present disclosure.

FIG. 10 depicts a frequency response graph for an E-plane waveguide filter according to the present disclosure.

FIG. 11A illustrates an E-plane waveguide filter according to the present disclosure.

FIG. 11B illustrates an E-plane waveguide filter according to the present disclosure.

FIG. 11C illustrates dielectric blocks according to the present disclosure.

FIG. 11D illustrates dielectric blocks according to the present disclosure.

FIG. 11E illustrates an E-plane waveguide filter according to the present disclosure.

FIG. 11F1 depicts a coupling model according to the present disclosure.

FIG. 11F2 depicts an E-plane waveguide filter according to the present disclosure.

FIG. 11F3 depicts a frequency response graph according to the present disclosure.

FIG. 12 depicts a process for assembling an E-plane waveguide filter according to the present disclosure.

### DETAILED DESCRIPTION

In this respect, before explaining at least one embodiment of the invention in detail, it is to be understood that the invention is not limited in its application to the details of construction and to the arrangements of the components set forth in the following description or illustrated in the drawings. The invention is capable of embodiments or embodiments in addition to those described and of being practiced and carried out in various ways. Also, it is to be understood that the phraseology and terminology employed herein, as well as the abstract, are for the purpose of description and should not be regarded as limiting.

Reference in this application to “one embodiment,” “an embodiment,” “one or more embodiments,” or the like means that a particular feature, structure, or characteristic described in connection with the embodiment is included in at least one embodiment of the disclosure. The appearances of, for example, the phrases “an embodiment” in various places in the specification are not necessarily all referring to the same embodiment, nor are separate or alternative embodiments mutually exclusive of other embodiments. Moreover, various features are described which may be exhibited by some embodiments and not by the other. Similarly, various requirements are described which may be requirements for some embodiments but not by other embodiments.

E-plane waveguide filters and associated methods are described herein. In some cases, a structure of a ceramic filter may include one or more resonators and one or more coupling windows. The structure may include a plurality of coupled metalized dielectric blocks. Coupling structures may be pressed, machined, lased, or screen printed onto or into each of the metallized dielectric blocks. An RF E-plane waveguide filter may be formed by attaching the coupling structures to each other. Moreover, one or more of resonators, a metalized septum for inter-resonator couplings, and/or various input and output couplings, loops, or probes for input loading into the filter may be pressed, machined, lased, or screen printed onto\into the blocks, e.g., eliminating the need for a separate septum. By reducing the part count of the E-plane filter and/or decreasing its complexity, the structure of the E-plane filter may be manufactured more efficiently and its associated costs may be decreased.

According to some aspects, an E-plane waveguide filter may be divided in half (e.g., along a narrow wall of the E-plane waveguide filter) into ceramic blocks (e.g., two rectangular shaped blocks). The ceramic blocks may be connected or assembled to create the E-plane waveguide filter. The ceramic blocks may be coupled through an inductive window (e.g., of varying shapes and sizes) on the narrow wall.

According to some aspects, each of the ceramic blocks may be plated. A pattern (e.g., pattern artwork) may be created (e.g., by lasing or screen printing) on one or more of the blocks. The pattern may simultaneously create one or more of resonators, metalized septum for inter-resonator couplings, and various input and output couplings loops or probes for the input loading into the filter. For example, a pattern artwork may couple the electric field through the filter's resonators (e.g., created by periodic open windows). Metalized septa between the windows may create inductive couplings between each resonator pair. Moreover, a surface mount, loop, or probe input coupling may be incorporated into the pattern artwork to create either capacitive or inductive input and output couplings (e.g., loading) into the filter.

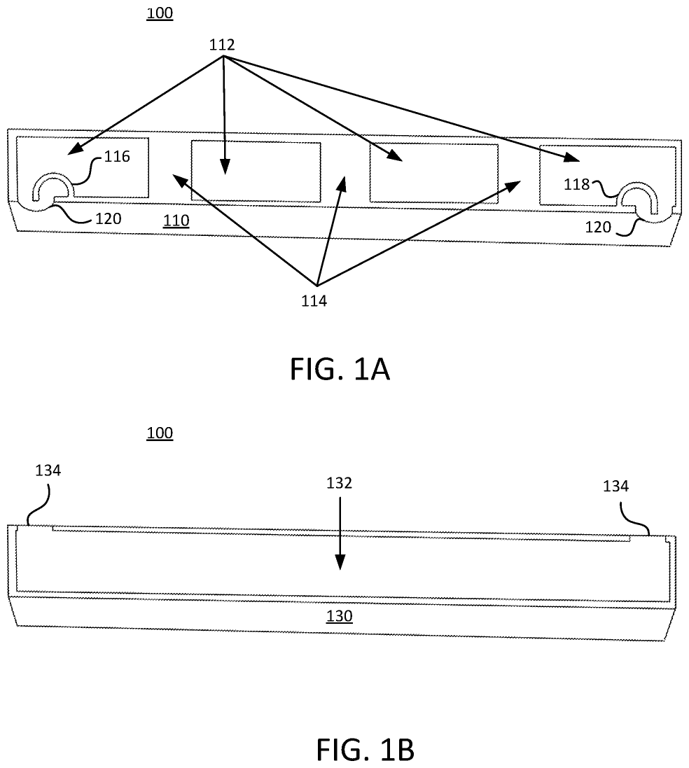

FIGS. 1A and 1B depict an E-plane waveguide filter 100 according to the present disclosure. As illustrated in FIG. 1A, the E-plane waveguide filter 100 may include a first dielectric block 110. The first dielectric block 110 may be comprised of ceramic. The first dielectric block 110 may define one or more of length, width, and thickness dimensions. Moreover, the E-plane waveguide filter 100 may be comprised of a plurality of dielectric blocks. As illustrated in FIG. 1B, the E-plane waveguide filter 100 may include a second dielectric block 130. The second dielectric block 130 may be comprised of ceramic. The second dielectric block 130 may define one or more of length, width, and thickness dimensions. In some cases, the first dielectric block 110 and/or the second dielectric block 130 may be coated with a metallic substance. For example, the metallic substance may be formed on one or more outer surfaces of the first dielectric block 110 and/or the second dielectric block 130.

The first dielectric block 110 may be coupled to the second dielectric block 130 along respective longitudinal surfaces of the first dielectric block 110 and the second dielectric block 130. A surface of each block (e.g., first dielectric block 110 and/or second dielectric block 130) may comprise a metallic coating. For example, the first dielectric block 110 and/or second dielectric block 130 may be coated with a metallic substance prior to coupling to the other blocks of the E-plane waveguide filter 100.

Various structures may be formed on one or more surfaces of the blocks (e.g., first dielectric block 110 and/or second dielectric block 130) of the E-plane waveguide filter 100. For example, patterns (e.g., resonator windows, inductive windows, etc.) may be formed on the one or more surfaces by using lasers, plasma, or chemical processes to remove plating. In another example, additive processes (e.g., screen printing or metal ink printing) may be used to form patterns on the one or more surfaces. The patterns may be formed on one or more adjoining block surfaces to create various structures (e.g., resonator windows, inductive windows, etc.) of the E-plane waveguide filter 100.

For example, first dielectric block 110 may include a plurality (e.g., four) of resonator windows 112. For example, one or more resonator windows 112 (e.g., between adjacent blocks) may be formed on a surface of a block through additive processes (e.g., exposing portions of the block by adding a metallic material to other portions of the block) or by removing a metallic plating on a plated surface of the block (e.g., exposing portions of the block where the metallic plating is removed). The one or more resonator windows 112 may expose a dielectric material within a block.

The one or more resonator windows 112 may be any size or shape, and may be an array of shapes and sizes. For example, each window of the one or more resonator windows 112 may be any planer geometric shape (e.g., rectangle, oval, polygonal, etc.). Moreover, each window of the one or more resonator windows 112 may be a different geometric shape relative to one or more of the other windows, and each window's height may be different. In some examples, a resonant frequency of the resonator may be determined by a length of the one or more resonator windows 112.

The resonator windows 112 may be separated (e.g., in the height dimension) by inter-resonator coupling septum or septa 114. Each inter-resonator coupling septum 114 may span the height of the window, and may run substantially parallel to a height dimension of a block. Moreover, the septa 114 may be any shape and size, provided the septa 114 disrupt the electric field to create a coupling between the one or more resonator windows 112. For example, if the one or more resonator windows 112 are oval shaped, the septa 114 may be an hour-glass shape.

A first distal end of the first dielectric block 110 (e.g., a top surface of the E-plane waveguide filter 100) may include an input loading interface 116 (e.g., loop or probe input coupling). The input loading interface 116 may facilitate receiving a radio frequency signal from an input and/or transmitting the radio frequency signal to the E-plane waveguide filter 100. Moreover, the input loading interface 116 may control the input loading bandwidth, e.g., contributing to the actual filter passband frequency bandwidth of the E-plane waveguide filter 100. The input loading interface 116 may act as an impedance transformer to transition from an rf connector (e.g., a 50 ohm rf connector) to the internal waveguide impedance of the E-plane waveguide filter 100. The internal waveguide impedance of the E-plane waveguide filter 100 may be significantly higher or lower than the impedance of the rf connector.

An impedance transformer (e.g., input loading interface 116) may provide a way to match two different impedances such that undesirable performance is avoided. Because any disagreement between the characteristic impedance of outside connections (e.g., input loading interface 116) and the internal impedances of the E-plane waveguide filter 100 may cause more signal power to be reflected and/or allow less signal power to be transmitted through the filter, impedance matching may positively impact the performance of a microwave circuit. Accordingly, input loading interface 116 may shape the electrical frequency response of the filter. For example, larger input and/or output loops may allow for wider passband filter responses, and smaller input and/or output loops may facilitate narrower passband filter responses.

A second distal end of the first dielectric block 110 (e.g., a top surface of the E-plane waveguide filter 100) may include an output loading interface 118 (e.g., loop or probe input coupling). The output loading interface 118 may facilitate transmitting a radio frequency signal (e.g., to another device) from the E-plane waveguide filter 100. First dielectric block 110 may include one or more apertures 120. For example, one or more of the input loading interface 116 and the output loading interface 118 may pass through one or more of the apertures 120.

The second dielectric block 130 may include a mating block pattern 132. For example, the mating block pattern 132 may correspond with a pattern of the first dielectric block 110 (e.g., resonator windows 112, inter-resonator coupling septum or septa 114, input loading interface 116, and/or output loading interface 118). Moreover, second dielectric block 130 may include one or more apertures 134, e.g., corresponding with apertures 120 of first dielectric block 110. When coupled, blocks may define resonator segments throughout the coupled blocks, where the characteristics of the resonator segments (e.g., resonant frequency, etc.) may be defined by the positioning, size, and shapes of the resonator windows 112 and inter-resonator coupling septum or septa 114. Additionally, resonator windows 112 may be defined between first dielectric block 110 and second dielectric block 130. As illustrated by FIG. 1A, first dielectric block 110 includes 4 resonator windows 112, 3 septa 114, an input loading interface 116, and an output loading interface 118. As illustrated by FIG. 1B, second dielectric block 130 may include 1 resonator window (e.g., mating block pattern 132) and two apertures 134.

According to some aspects, ease of manufacturability of second dielectric block 130 may be increased by the relatively large size of the resonator window (e.g., mating block pattern 132) in relation to the resonator windows 112 of first dielectric block 110. In the example illustrated in FIGS. 1A and 1B, the smaller resonator windows 112 of first dielectric block 110 may dominate the shaping of the filter response. Moreover, risk of misalignment of the first dielectric block 110 and the second dielectric block 130 may be eliminated or reduced by including resonator windows of different sizes in each of the blocks. For example, any misalignment occurring when mating two blocks with same size windows may create a window between the two blocks (e.g., smaller than desired by design), and may change the filter's frequency response in an undesirable way.

In another example, both the first dielectric block 110 and the second dielectric block 130 may have a same or similar number of resonator windows. If the corresponding mating resonator windows of the second dielectric block 130 are larger (e.g., in all dimensions) than the resonator windows of the first dielectric block 110, then the resonator windows of the first dielectric block 110 (e.g., the smaller resonator windows) may determine the strength of the fields passing through the paired resonator windows. Moreover, the resonator windows of the first dielectric block 110 (e.g., the smaller resonator windows) may determine the final filter response shape.

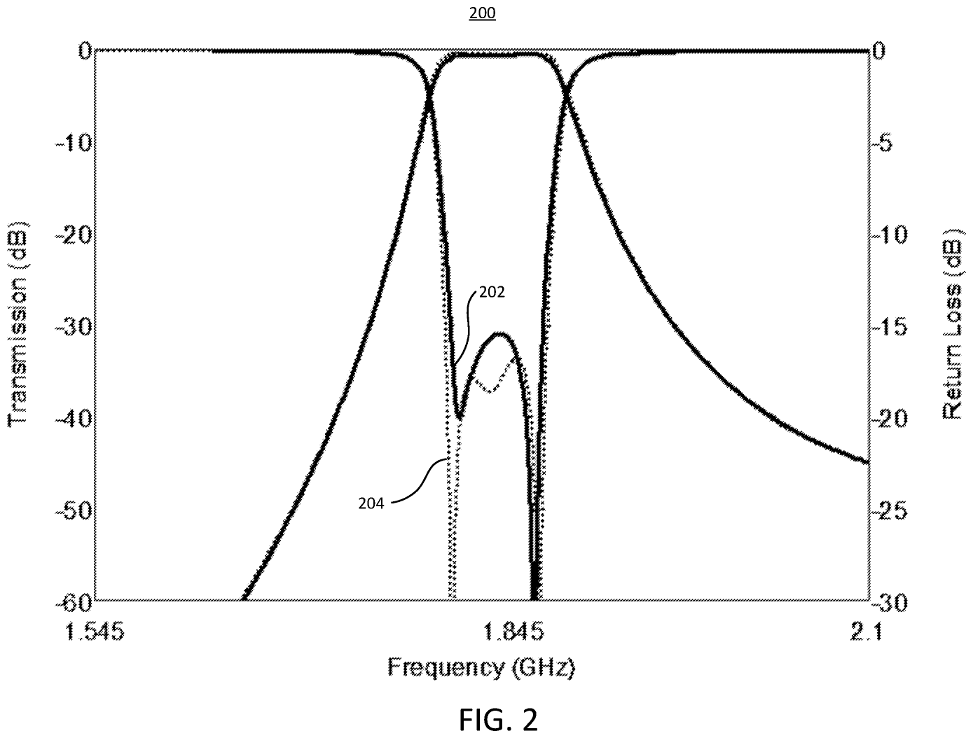

FIG. 2 depicts a frequency response graph 200 for an E-plane waveguide filter (e.g., E-plane waveguide filter 100) according to the present disclosure. The frequency response graph 200 may be associated with a performance of the E-plane waveguide filter 100 depicted in FIGS. 1A and 1B. For example, the frequency response graph 200 includes two filter responses. The solid line shows measured filter response 202, and the dashed line shows simulated data filter response 204. The correspondence of the measured filter response 202 and the simulated data filter response 204 illustrates that, according to some aspects, E-plane waveguide filter 100 is translated from simulation to production with reliable results. Moreover, agreement of the measured filter response 202 and the simulated data filter response 204 may be increased based on one or more production variables (e.g., patterns formed on the first dielectric block 110 and the second dielectric block 130).

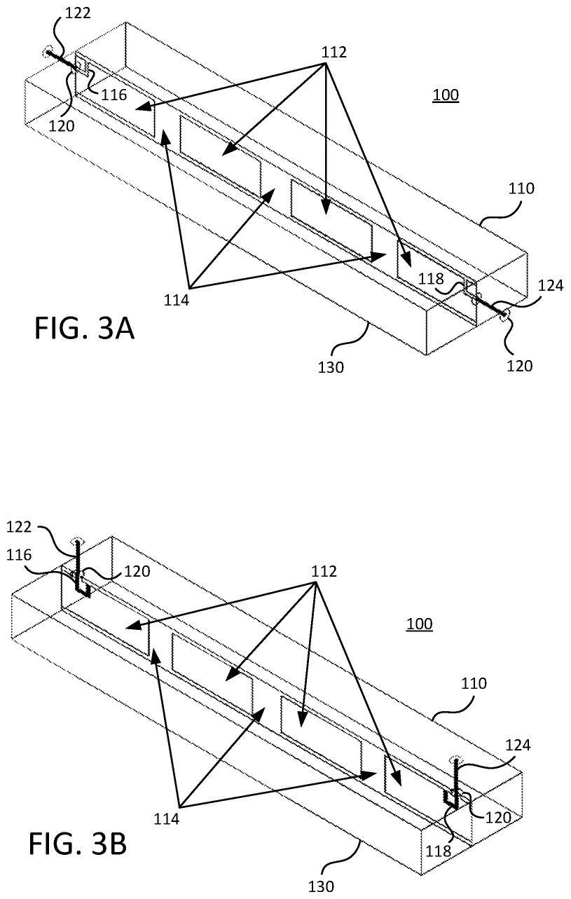

FIGS. 3A and 3B depict an E-plane waveguide filter 100 according to the present disclosure. For example, the E-plane waveguide filter 100 may be an E-plane 4-pole filter. The E-plane waveguide filter 100 may include a first dielectric (e.g., ceramic) block 110 coupled to a second dielectric (e.g., ceramic) block 130. The first dielectric block 110 may be coupled to the second dielectric block 130 along respective longitudinal surfaces of the first dielectric block 110 and the second dielectric block 130. A surface of each block (e.g., first dielectric block 110 and/or second dielectric block 130) may comprise a metallic coating. For example, the first dielectric block 110 and/or second dielectric block 130 may be coated (e.g., plated) with a metallic substance.

One or more surfaces of the blocks (e.g., first dielectric block 110 and/or second dielectric block 130) of the E-plane waveguide filter 100 may be etched to form various structures contained in the E-plane waveguide filter 100. Patterns may be printed on one or more adjoining block surfaces to create various structures (e.g., resonator windows 112, inter-resonator coupling septa 114, etc.) of the E-plane waveguide filter 100.

A first distal end of E-plane waveguide filter 100 may include an inductive input launch (e.g., input loading interface 116) coupled to an input coupling 122. A second distal end of the E-plane waveguide filter 100 may include an output loading interface 118, e.g., coupled to output coupling 124. As illustrated in FIG. 3A, the input loading interface 116 and/or output loading interface 118 may be an end loop launch (e.g., rectangular loop). As illustrated in FIG. 3B, the input loading interface 116 and/or output loading interface 118 may be a top loop launch (e.g., rectangular loop). According to some aspects, the input loading interface 116 and/or output loading interface 118 may be surface mounted (e.g., may not require an external RF connector). For example, the output loading interface 118 may comprise an input/output surface mount pad electrically coupled to a capacitive input/output launch.

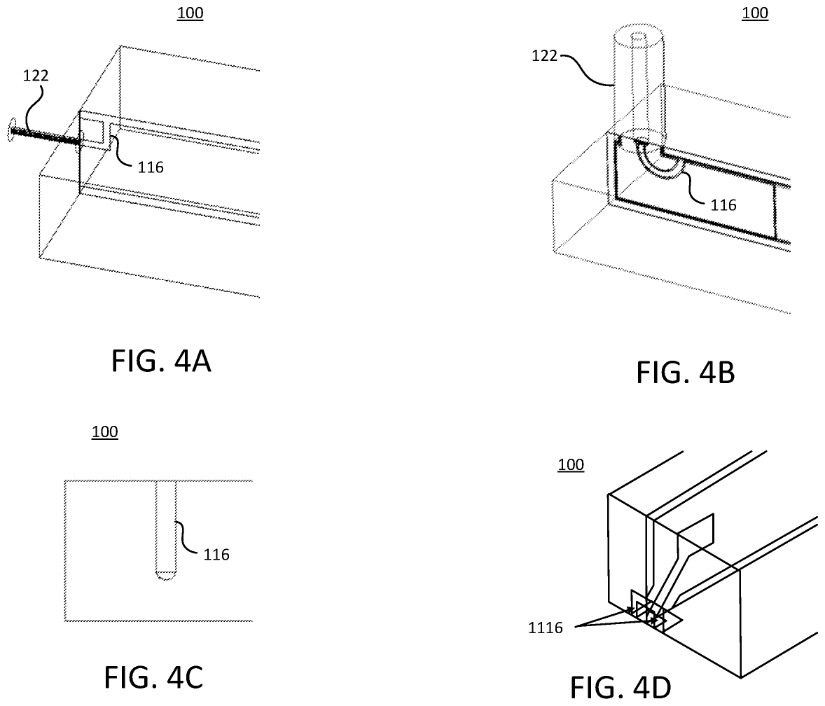

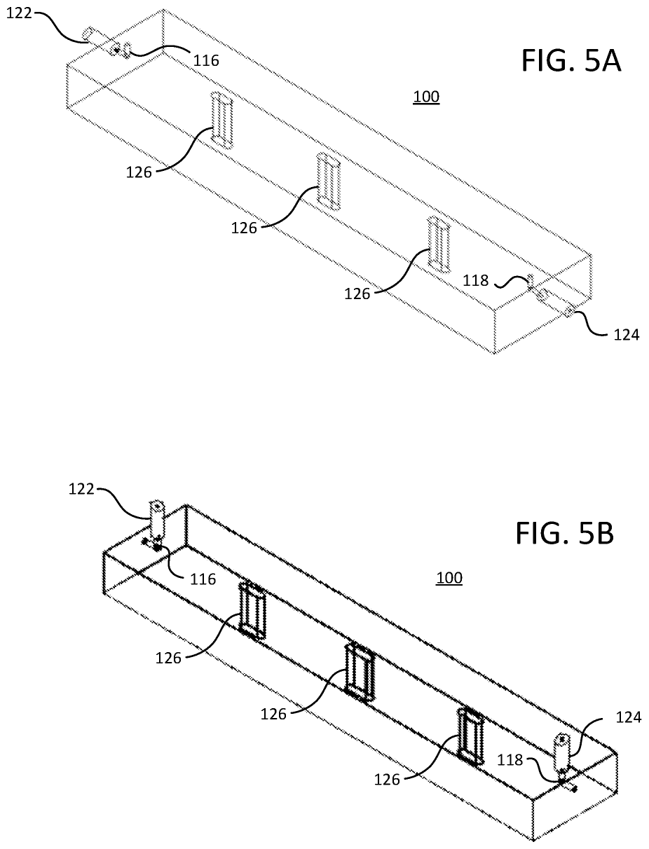

E-plane waveguide filter 100 may include one or more apertures 120. For example, one or more of the input loading interface 116 and the output loading interface 118 may pass through one or more of the apertures 120. Input coupling 122 and/or output coupling 124 may be rectangular (e.g., as illustrated in FIGS. 3A, 3B, and 4A), circular (e.g., FIG. 4B), or a polygonal shape. According to some aspects, the input loading interface 116 and/or the output loading interface 118 may be manipulated based on one or more of system layout requirements (e.g., direction the RF connectors come out of the E-plane waveguide filter 100), impedance matching, and RF filter frequency response requirements. Moreover, the input coupling 122 and/or output coupling 124 may be oriented from a side (e.g., as illustrated in FIGS. 3A and 4A), top-to bottom (e.g., as illustrated in FIGS. 3B and 4B), have varying width of loops, and/or chamfered from edge. In some aspects the input coupling 122 and/or output coupling 124 may be surface mount or cap probe (e.g., capacitor launch probe) couplings, as illustrated in FIG. 4D. FIG. 4C illustrates a machined or pressed capacitive probe that may be used in filters (e.g., FIG. 5A or 5B type filters) where the septum are pressed or machined into the block. According to some aspects, the input coupling 122 and/or the output coupling 124 may be surface mount connections, as illustrated in FIG. 4D. For example, the input coupling 122 and/or the output coupling 124 may be connected directly to a circuit board.

FIGS. 5A and 5B depict an E-plane waveguide filter 100 according to the present disclosure. As illustrated in FIGS. 5A and 5B, input coupling 122, output coupling 124, and/or septum loadings 126 may be pressed into the E-plane waveguide filter 100 (e.g., first dielectric block 110 and/or second dielectric block 130). According to some aspects, pressing the input loading interface 116 and/or the output loading interface 118 may prevent the first dielectric block 110 and/or the second dielectric block 130 from being ejected from a press mold. The input loading interface 116 and/or the output loading interface 118 may be respectively machined (or partially machined) into the first dielectric block 110 and/or the second dielectric block 130. Moreover, the input loading interface 116 and/or the output loading interface 118 may be 3D printed. According to some aspects, input coupling 122, output coupling 124, and/or septum loadings 126 may be lasered into the E-plane waveguide filter 100 (e.g., first dielectric block 110 and/or second dielectric block 130).

According to some aspects, pressing one or more of input coupling 122, output coupling 124, and/or septum loadings 126 into the E-plane waveguide filter 100 may facilitate higher power handling (e.g., in comparison with lasered septa or input/output interfaces) and may be easier to tune the septum in production. According to some aspects, air gaps created by lasing or screen printing the patterns (e.g., resonator windows, inductive windows, etc.) may reduce the power rating of the E-plane waveguide filter 100. For example, the patterns (e.g., resonator windows, inductive windows, etc.) may have a lower voltage breakdown rating than the first dielectric block 110 and/or the second dielectric block 130 because, when the electric field strength in a medium (e.g., air) may exceed a voltage breakdown rating associated with the dielectric material and arcing may occur. The arcing may reduce the power rating of the E-plane waveguide filter 100. Pressing the septum or septa 114 into the first dielectric block 110 and/or the second dielectric block 130 and then plating the septum holes and outside of the first dielectric block 110 and/or the second dielectric block 130 may eliminate any air windows (e.g., otherwise resulting from laser and screen-printing). The pressed septa 114 may comprise a solid, high-breakdown ceramic material. Moreover, access to the inside of the pressed septa 114 may allow plating metal to be removed for tuning.

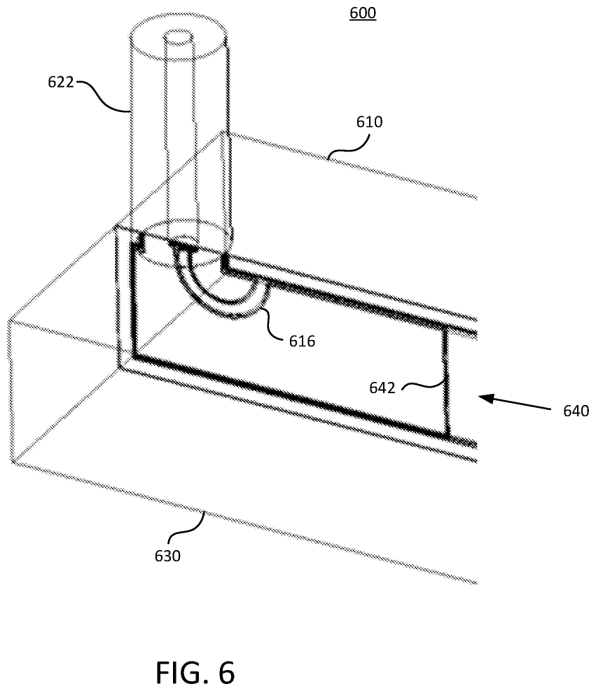

According to some aspects, an E-plane input launch may be used to launch into a non-E-plane waveguide. As illustrated in FIG. 6, an E-plane waveguide filter 600 may include a first dielectric (e.g., ceramic) block 610. The first dielectric block 610 may define one or more of length, width, and thickness dimensions. Moreover, the E-plane waveguide filter 600 may be comprised of a plurality of dielectric blocks. For example, the E-plane waveguide filter 600 may include a second dielectric (e.g., ceramic) block 630. The second dielectric block 630 may define one or more of length, width, and thickness dimensions. In some cases, the first dielectric block 610 and/or the second dielectric block 630 may be coated with a metallic substance (e.g., formed on an outer surface). The first dielectric block 610 may be coupled to the second dielectric block 630 along respective longitudinal surfaces of the first dielectric block 610 and the second dielectric block 630. A surface of each block (e.g., first dielectric block 610 and/or second dielectric block 630) may comprise a metallic coating. For example, the first dielectric block 610 and/or second dielectric block 630 may be coated with a metallic substance prior to coupling to the other blocks of the E-plane waveguide filter 600.

According to some aspects, E-plane waveguide filter 600 may include two E-plane waveguide blocks (e.g., first dielectric block 610 and/or second dielectric block 630) and a non-E-plane waveguide (e.g., standard waveguide 640). For example, standard waveguide 640 may be a rectangular (e.g., one block) waveguide. E-plane waveguide filter 600 may include an input loading interface 616 (e.g., a loop coupling) coupled to an input coupling 622.

One or more surfaces of the blocks (e.g., first dielectric block 610, second dielectric block 630, and/or standard waveguide 640) of the E-plane waveguide filter 600 may be etched to form various structures contained in the E-plane waveguide filter 600. Patterns may be printed on one or more adjoining block surfaces to create various structures (e.g., resonator windows, inductive windows, etc.) of the E-plane waveguide filter 600.

For example, E-plane waveguide filter 600 may include an input loading interface 616 (e.g., a loop coupling) into an E-plane waveguide comprising two blocks (e.g., first dielectric block 610 and/or second dielectric block 630). The E-plane waveguide filter 600 may further include a window coupling (e.g., coupling 642) to a dielectric (e.g., ceramic) non-E-plane waveguide (e.g., standard waveguide 640).

Rather than manufacturing an input launch into a hardened ceramic block, incorporating an input launch hole via an expensive press tool, or buying expensive machining equipment capable of accurately machining an input/output launch hole, the loop coupling (e.g., input loading interface 616) may significantly improve manufacturability (e.g., relative to conventional ceramic waveguide filters). Moreover, the loop coupling (e.g., input loading interface 616) may eliminate any necessity for further secondary machining (e.g., associated with conventional ceramic waveguide filters) to adjust the hole height to control the input loading of the RF filter, as well as additional hole plating processes. Relative to traditional ceramic waveguide filters (e.g., filters without a septum that require machining coupling walls or machining separate resonators and then assembling the filters) E-plane waveguide filter 600 only requires two blocks (e.g., first dielectric block 610 and the second dielectric block 630) with patterns printed on one or more adjoining block surfaces to create various structures (e.g., coupling 642, etc.) of the E-plane waveguide filter 600.

In comparison with conventional E-plane filters, lapping two rectangular blocks (e.g., first dielectric block 610 and the second dielectric block 630) to the correct dimensions for a specific ceramic lot dielectric is a very simple process that requires inexpensive and readily available equipment, and can be manufactured in high volume (e.g., relatively easily and accurately). Moreover, according to some aspects, plating a rectangular block (e.g., first dielectric block 610 and the second dielectric block 630) may provide a simple and straight-forward manufacturing process. According to some aspects, there are no holes to metalize in the E-plane waveguide filter 600. For example, input\output loops may control the loading to E-plane waveguide filter 600 and the patterns printed on one or more adjoining block surfaces to create various structures (e.g., coupling 642, etc.) of the E-plane waveguide filter 600 may be adjusted (e.g., by changing a laser artwork file). Because lasers have far better dimensional accuracy (e.g., fractions of a thousandth of an inch) than conventional machining processes (e.g., typically thousandths or more tolerance), ceramic lot-to-lot dielectric variations may be adjusted in real-time.

Moreover, transitioning from a 2-block E-plane launch (e.g., input loading interface 616) to a single-block waveguide (e.g., standard waveguide 640) may improve power handling. For example, the input\output loading in conventional RF filters has very little associated stored energy and is not typically a failure point in conventional RF filters. Rather, the failure point in RF filters typically occurs in the center-most resonators, e.g., nearest to the port where RF power is applied. In E-plane waveguide filter 600, transitioning from E-plane launch to solid waveguide resonators may remove any air in center-located resonators (e.g., where arcing is far more likely to occur). Additionally, a hybrid E-plane launch (e.g., input loading interface 616) to a non-E-plane waveguide (e.g., standard waveguide 640) may improve filter passband loss (e.g., by reducing metal associated with the resonator). For example, filter passband loss may be reduced (e.g., improving resonator quality factor and/or reducing Q degradation) by reducing added metal required to allow for soldering the two blocks together.

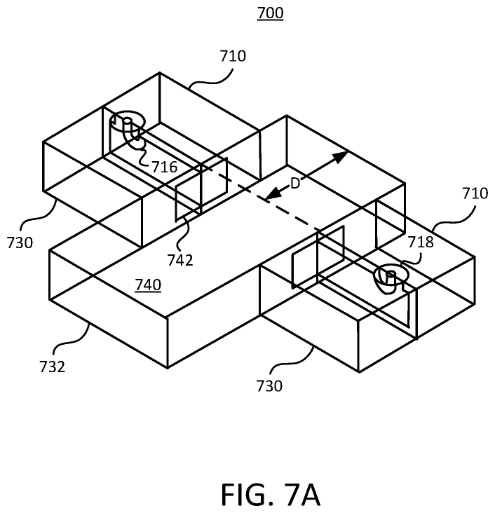

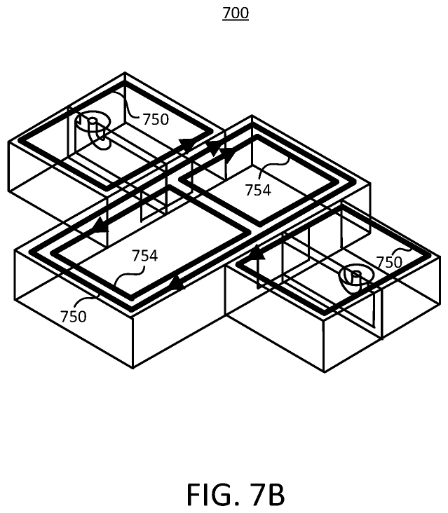

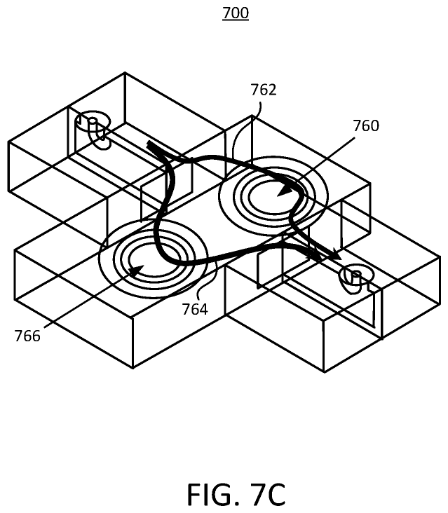

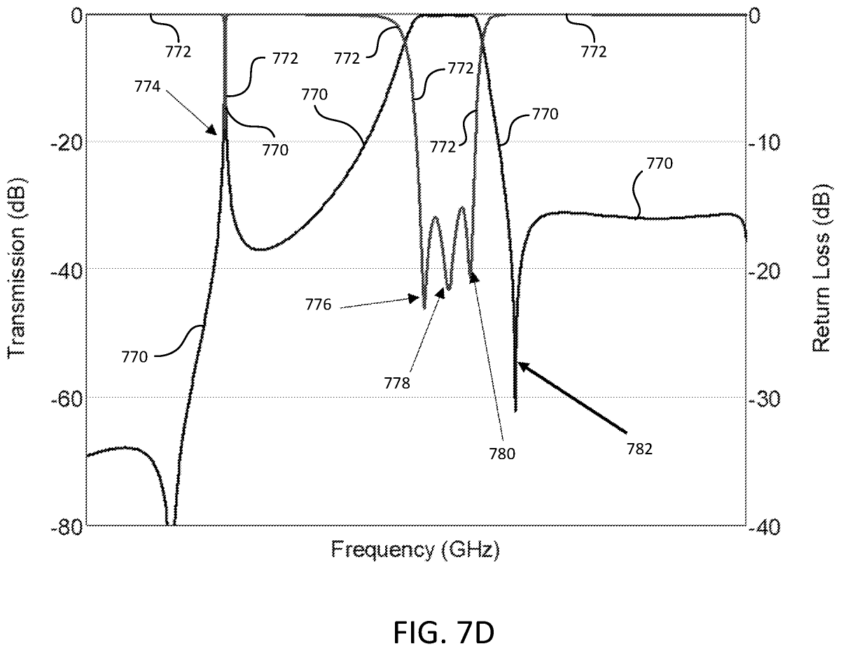

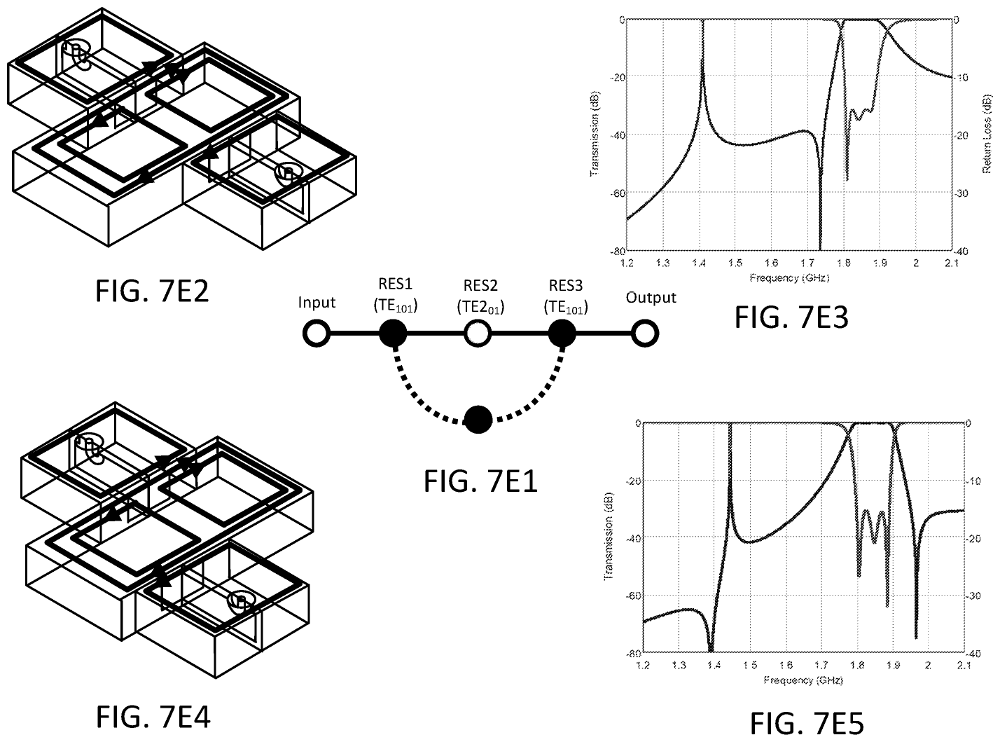

According to some aspects, an E-plane input launch may be used to launch into a non-E-plane dual-mode waveguide (e.g., to create transmission zeros in filter response). For example, a 3-pole filter may create low-side transmission zeros. As illustrated in FIG. 7A, an E-plane waveguide filter 700 may be comprised of a plurality of dielectric blocks. For example, the E-plane waveguide filter 700 may include 2 first dielectric (e.g., ceramic) blocks 710, 2 second dielectric (e.g., ceramic) blocks 730, and a third dielectric (e.g., ceramic) block 732. Each of the first dielectric blocks 710, the second dielectric blocks 730, and/or the third dielectric block 732 may define one or more of length, width, and thickness dimensions.

In some cases, the first dielectric block 710, the second dielectric block 730, and/or the third dielectric block 732 may be coated with a metallic substance (e.g., formed on an outer surface). The first dielectric blocks 710 may be coupled to corresponding second dielectric blocks 730 along respective longitudinal surfaces of the first dielectric blocks 710 and the second dielectric blocks 730. A surface of each block (e.g., first dielectric block 710 and/or second dielectric block 730) may comprise a metallic coating. For example, the first dielectric block 710 and/or second dielectric block 730 may be coated with a metallic substance prior to coupling to the other blocks of the E-plane waveguide filter 700.

According to some aspects, E-plane waveguide filter 700 may include two E-plane waveguide blocks (e.g., each comprised of first dielectric block 710 and/or second dielectric block 730) and a non-E-plane waveguide (e.g., third dielectric block 732 forming dual-mode rectangular waveguide 740). For example, third dielectric block 732 may comprise a dual-mode rectangular waveguide 740. Dual-mode rectangular waveguide 740 may be a rectangular (e.g., one block) waveguide. Moreover, E-plane waveguide filter 700 may comprise one or more couplings, e.g., input loading interface 716 (e.g., a loop coupling) and output loading interface (e.g., a loop coupling) 718.

One or more surfaces of the blocks (e.g., first dielectric block 710, second dielectric block 730, and/or third dielectric block 732) of the E-plane waveguide filter 700 may be etched to form various structures contained in the E-plane waveguide filter 700. Patterns may be printed on one or more adjoining block surfaces to create various structures (e.g., resonator windows, inductive windows, etc.) of the E-plane waveguide filter 700.

For example, E-plane waveguide filter 700 may include an input loading interface 716 (e.g., a loop coupling) into an E-plane waveguide comprising two blocks (e.g., first dielectric block 710 and/or second dielectric block 730). The E-plane waveguide filter 700 may further include a window coupling (e.g., coupling 742) to a dielectric (e.g., ceramic) non-E-plane waveguide (e.g., dual-mode cavity 740).

According to some aspects, a loop coupling into an E-plane waveguide (e.g., first dielectric blocks 710 and/or second dielectric blocks 730) may be easy to manufacture (e.g., relative to traditional E-plane waveguide filters). For example, pressing the input loading interface 716 and/or the output loading interface 718 may prevent the first dielectric blocks 710 and/or the second dielectric blocks 730 from being ejected from a press mold. The input loading interface 716 and/or the output loading interface 718 may be respectively machined (or partially machined) into one or more of the first dielectric blocks 710 and/or the second dielectric blocks 730. Moreover, the input loading interface 116 and/or the output loading interface 118 may be 3D printed.

According to some aspects, third dielectric block 732 may comprise a dual-mode cavity 740, e.g., forming a dual-mode solid block resonator. For example, FIG. 7A illustrates 2 input and output resonators (e.g., each comprising first dielectric block 710 and/or second dielectric block 730) with input/output loading loops (e.g., input loading interface 716 and output loading interface 718). The input and output resonators may be connected to a larger dual mode cavity (e.g., third dielectric block 732 comprising dual-mode cavity 740). For example, dual-mode cavity 740 may be a solid cavity and may not comprise a septum in the center. The input/output resonators (e.g., each comprising first dielectric block 710 and/or second dielectric block 730) may be moved (e.g., a distance D from a distal end of dual mode cavity 740) to couple into resonant modes of the larger center cavity (e.g., TE₁₀₁ and TE₂₀₁ modes).

For example, as illustrated in FIG. 7B, input/output resonators (e.g., respective coupled first dielectric blocks 710 and second dielectric blocks 730) may operate in a resonant mode TE₁₀₁ 750 (e.g., with a passband frequency of f₀) and a dual-mode cavity (e.g., dual mode cavity 740) may operate in a resonant mode TE₁₀₁ 750 (e.g., with a passband frequency of half f₀). E-plane waveguide filter 700 may provide a window coupling into an E-plane dual mode waveguide (dual mode cavity 740) through a TE₂₀₁ mode 754 to create a low-side transmission zero. According to some aspects, a pole may be created below a passband of the E-plane waveguide filter 700. This technique may take advantage of the dual-mode cavity 740 being able to support two resonant modes: one mode (e.g., TE₂₀₁ 754) that resonates at the passband frequency of the E-plane waveguide filter 700 and another resonant mode (e.g., TE₁₀₁ 750) that resonates at half the passband frequency of the filter. The resonant mode (e.g., TE₁₀₁ 750) that resonates at half the bandpass center frequency may create a resonant mode below the passband of the E-plane waveguide filter 700.

As illustrated in FIG. 7C, the E-plane waveguide filter 700 may couple strongly into one of the dual-mode cavity modes to create the passband response. Moreover, shifting the two input and output E-planer launches (e.g., respective coupled first dielectric blocks 710 and second dielectric blocks 730) relative to each other may strongly couple into one of the dual-mode cavities (e.g., second resonant mode Res2 760) to create the passband response, e.g., lightly coupling the E-plane waveguide filter 700 into the second mode (e.g., second resonant mode Res2 766). Two RF paths may be created (e.g., RF Path 1 762 and RF Path 2 764) that may phase cancel at some location below the filter passband creating a transmission zero. The transmission zero may improve the RF filter's out-of-passband response, e.g., without adding poles inside the passband that will decrease passband loss and signal power going through the E-plane waveguide filter 700. Moreover, the pole below the band may or may be based on customer requirement and/or a specific application of the E-plane waveguide filter 700. For example, as illustrated in FIG. 7C, RF Path 1 762 and RF Path 2 764 may strongly couple at a second resonant mode Res2 760. A second resonant mode Res2 766 may be used to create a phase shift.

As illustrated in FIG. 7D, RF Path1 762 may create the 3-resonators in the passband as illustrated by the three dips in the return loss response 770. RF Path2 764 may create a phase shift (e.g., with the second resonant mode Res2 766) that creates a transmission zero 782 on the low side of the illustrated passband. Changing the distance of the input/output resonators (e.g., respective coupled first dielectric blocks 710 and second dielectric blocks 730) from a distal end of the dual mode cavity 740 (e.g., distance D) may move the location of the transmission zero 782.

According to some aspects, the second resonant mode Res2 766 does not contribute to the shaping the passband of the E-plane waveguide filter 700. For example, only 3 resonators make up the passband even though there are 4-resonant modes available. FIG. 7D illustrates a return loss response 770 and an insertion loss response 772 for E-plane waveguide filter 700. TE101 @ ½-fₒ (e.g., Big Center Block) for E-plane waveguide filter 700 is illustrated at point 774. TE101 @ fₒ (e.g., input Assembly) for E-plane waveguide filter 700 is illustrated at point 776. TE201 @ fₒ (e.g., Big Center Block) for E-plane waveguide filter 700 is illustrated at point 778. TE101 @ fₒ (Output Assembly) for E-plane waveguide filter 700 is illustrated at point 780.

As illustrated in the coupling model of FIG. 7E1, when the input/output resonators (e.g., respective coupled first dielectric blocks 710 and second dielectric blocks 730) are spaced across from each other (e.g., as illustrated in FIG. 7E2), a low-side transmission zero is created by a phase shift through the Res2-TE101 mode that couples Res1 and Res3 (e.g., as illustrated in the frequency response graph of FIG. 7E3). When the IO's are not spaced across from each other (e.g., as illustrated in FIG. 7E4), a high-side transmission zero may be created by a phase shift through the Res2-TE101 mode and the changing phase shift in the TE₂₀₁ mode 754 because of the IO's offset (e.g., as illustrated in FIG. 7E5). Moreover, in both illustrated cases of FIGS. 7E2 and 7E4, the circuit model may not change. Moreover, in both illustrated cases of FIGS. 7E3 and 7E5, the passband may have three poles. In both illustrated cases of FIGS. 7E3 and 7E5, the resonant mode TE₁₀₁ 750 resonates below the passband of the E-plane waveguide filter 700. A transmission zero is created near the passband.

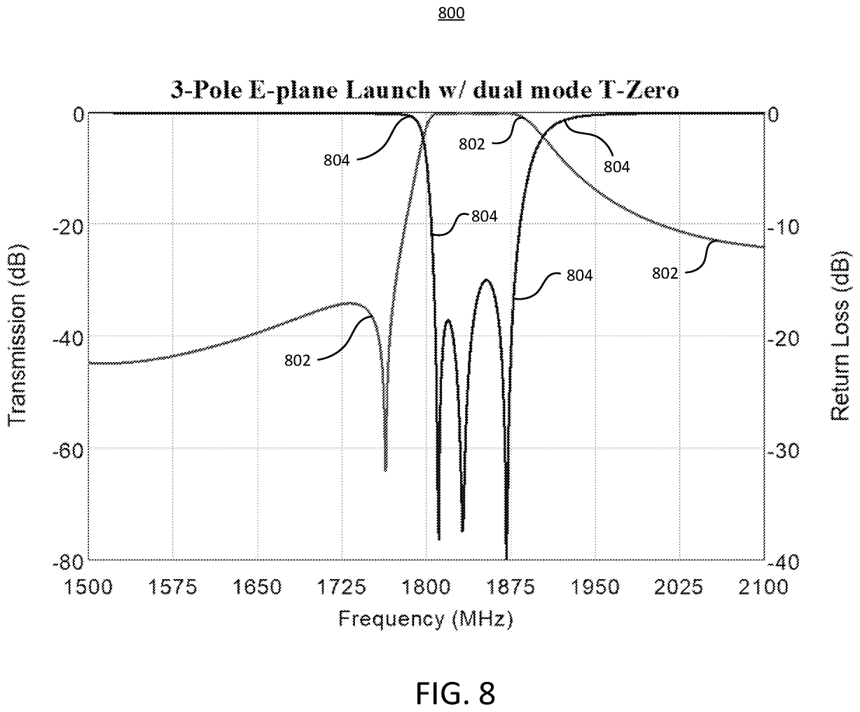

FIG. 8 depicts a frequency response graph 800 for an E-plane waveguide filter (e.g., E-plane waveguide filter 700) according to the present disclosure. The frequency response graph 800 may be associated with a performance of the E-plane waveguide filter 700 depicted in FIG. 7A. According to some aspects, trace 802 illustrates the power (e.g., in dB, where 0 dB represents most power transmitted through the filter) that goes through the E-plane waveguide filter 700. Moreover, trace 802 illustrates a transmission response starting at approximately −43 dB, has a transmission zero at approximately 1760 MHZ, increases to the passband of the E-plane waveguide filter 700, and slowly degrades to about −13 dB. According to some aspects, the transmission zero at approximately 1760 MHZ is created by the dual-mode cavity (e.g., rectangular waveguide 740) and RF paths (e.g., RF Path 1 762 and RF Path 2 764) that may phase cancel at some location below the filter passband creating the transmission zero.

Return loss trace 804 illustrates a reflective power from the input port of the E-plane waveguide filter 700 (in dB where 0 dB represent the frequencies where the most power reflect off the input port). Each dip in the return loss trace 804 represents a resonator that creates the filter passband. Two of the resonator “poles” are created from the two E-plane launches with their associated windows (e.g., first dielectric block 710, second dielectric block 730, and input loading interface 716).

The E-plane launch assemblies (e.g., first dielectric block 710, second dielectric block 730, and input loading interface 716) couple through a window (e.g., coupling 742) on the end of the E-plane assemblies that allows energy to strongly couple into one of the modes in the dual-mode cavity (e.g., dual-mode rectangular waveguide 740). This creates the third dip in the return loss trace 804. The two RF paths (e.g., RF Path 1 762 and RF Path 2 764) that realize the transmission zero at approximately 1760 MHz may be created based on the E-plane launch assemblies' location from relative to the dual-mode rectangular waveguide 740.

Shifting the E-plane assemblies on both side of the dual mode cavity (e.g., dual-mode rectangular waveguide 740) equally closer, or farther away from, the dual-mode cavity (e.g., dual-mode rectangular waveguide 740) block (e.g., upper-right end illustrated in FIG. 7A) may change the location of the 1760 MHZ transmission zero either lower in frequency (e.g., E-plane assemblies moving closer to an end of dual-mode rectangular waveguide 740 end) or higher in frequency in frequency (e.g., E-plane assemblies moving away from the end of dual-mode rectangular waveguide 740).

According to some aspects, the two E-plane assemblies (e.g., respective coupled first dielectric blocks 710 and second dielectric blocks 730) may be offset from each other, moving the transmission zero from the low-side of the passband to the high-side of the passband.

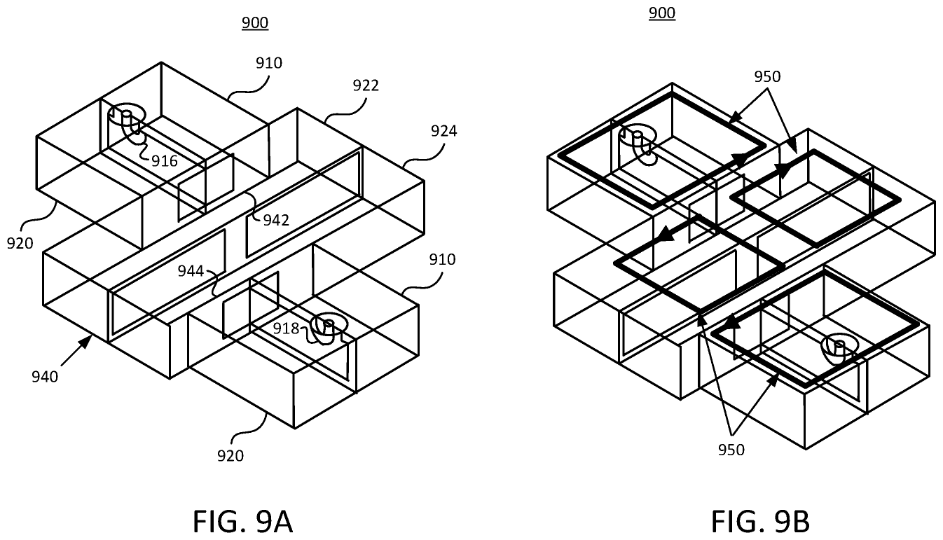

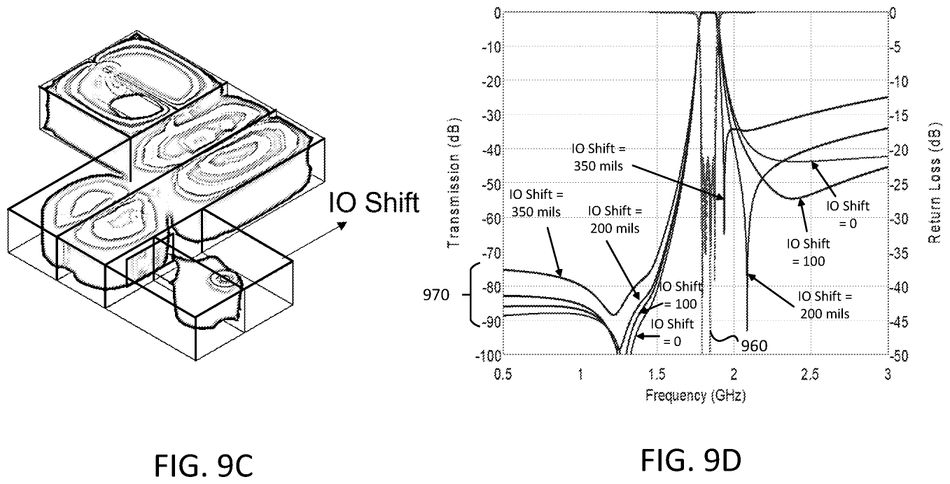

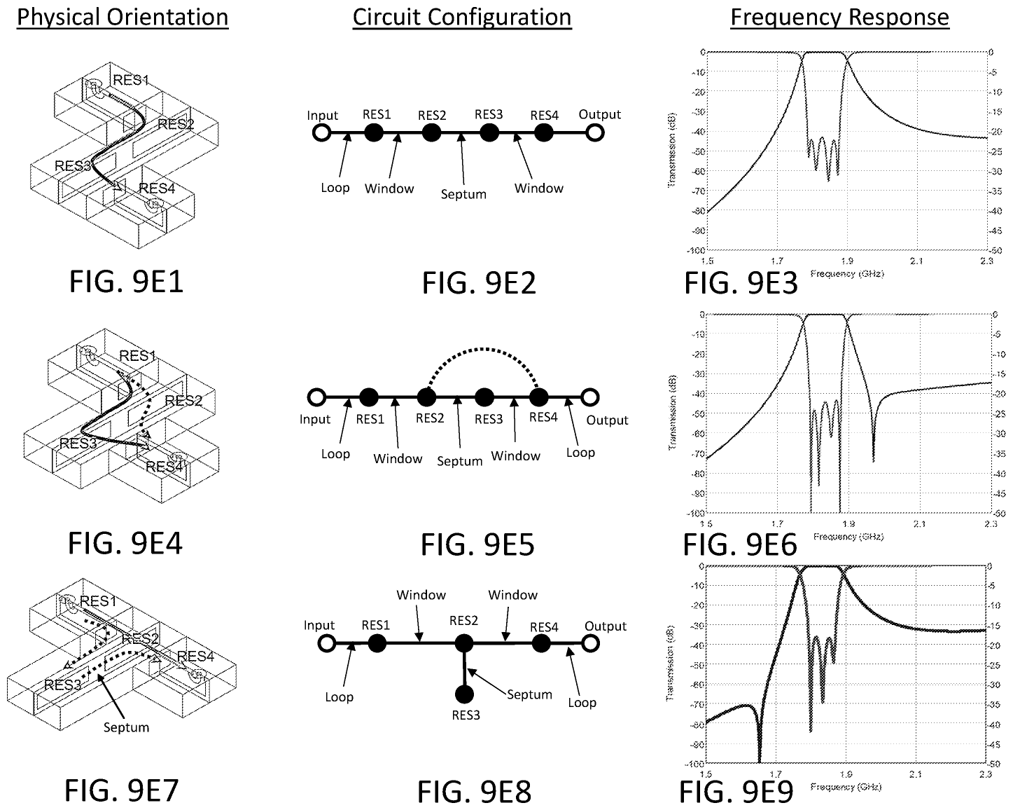

According to some aspects, an E-plane input launch may be used to launch into an E-plane waveguide (e.g., to create transmission zeros in filter response). As illustrated in FIGS. 9A and 9B, there may be a distinction between a dual-mode resonator from FIG. 7A and an E-plane block with 2 resonators.

For example, a 4-pole filter may create high-side transmission zeros. As illustrated in FIGS. 9A and 9B, an E-plane waveguide filter 900 may include a first plurality of dielectric (e.g., ceramic) blocks (e.g., blocks 910). The E-plane waveguide filter 900 may further include a second plurality of dielectric (e.g., ceramic) blocks (e.g., blocks 930). The first plurality of dielectric blocks (e.g., blocks 910) may be respectively coupled to the second plurality of dielectric blocks (e.g., blocks 930). The E-plane waveguide filter 900 may further include a third dielectric (e.g., ceramic) block (e.g., block 922) coupled to a fourth dielectric block (e.g., block 924). One or more blocks of the first plurality of dielectric blocks (e.g., blocks 910), the second plurality of dielectric blocks (e.g., blocks 930), the third dielectric block (e.g., block 922), and/or the fourth dielectric block (e.g., block 924) may define one or more of length, width, and thickness dimensions.

In some cases, one or more blocks of the first plurality of dielectric blocks (e.g., blocks 910), the second plurality of dielectric blocks (e.g., blocks 930), the third dielectric block (e.g., block 922), and/or the fourth dielectric block (e.g., block 924) may be coated with a metallic substance (e.g., formed on an outer surface). One or more blocks of the first plurality of dielectric blocks (e.g., blocks 910) may be coupled to one or more blocks of the second plurality of dielectric blocks (e.g., blocks 930) along respective longitudinal surfaces of the one or more blocks of the first plurality of dielectric blocks and the one or more blocks of the second plurality of dielectric blocks. The third dielectric block (e.g., block 922) may be coupled to the fourth dielectric block (e.g., block 924) along respective longitudinal surfaces of the third dielectric block (e.g., block 922) and the fourth dielectric block (e.g., block 924). A surface of each block may comprise a metallic coating. For example, one or more blocks of the first plurality of dielectric blocks (e.g., blocks 930), one or more blocks of the second plurality of dielectric blocks (e.g., blocks 930), the third dielectric block (e.g., block 922), and the fourth dielectric block (e.g., block 924) may be coated with a metallic substance prior to coupling to the other blocks of the E-plane waveguide filter 900.

According to some aspects, E-plane waveguide filter 900 may include two E-plane waveguide blocks (e.g., respectively coupled first dielectric blocks 910 and second dielectric blocks 930) and an E-plane waveguide (e.g., coupled third dielectric block 922 and fourth dielectric block 924, comprising E-plane waveguide 940). E-plane waveguide filter 900 may include an E-plane input loading interface 916 (e.g., a loop coupling or a surface mount open circuit stub) and an output loading interface 918 (e.g., a loop coupling or a surface mount open circuit stub).

One or more surfaces of the blocks of the E-plane waveguide filter 900 may be etched to form various structures contained in the E-plane waveguide filter 900. Patterns may be printed on one or more adjoining block surfaces to create various structures (e.g., resonator windows, inductive windows, etc.) of the E-plane waveguide filter 900.

For example, E-plane waveguide filter 900 may include an input loading interface 916 (e.g., a loop coupling) into an E-plane waveguide comprising two blocks (e.g., first dielectric block 910 and/or second dielectric block 930). E-plane waveguide filter 900 may include an output loading interface 918 (e.g., a loop coupling) into an E-plane waveguide comprising two blocks (e.g., first dielectric block 910 and/or second dielectric block 920). The E-plane waveguide filter 900 may further include one or more window couplings (e.g., coupling 942 and/or coupling 944) to an E-plane waveguide (e.g., E-plane waveguide 940).

According to some aspects, a loop coupling (e.g., coupling 942 and/or coupling 944) into an E-plane waveguide may be easy to manufacture (e.g., relative to traditional dielectric waveguide filters). An E-plane filter is a type of waveguide filter in which the waveguide is split in half along the center E-plane, and a thin metal “fin” is clamped between the two halves. Portions of the metal fin are cut out to realize shunt-inductive or shunt-capacitive discontinuities. A conventional waveguide filter does not cut the waveguide in half. Waveguide filters (e.g., E-plane waveguide filters) disrupt the electric or magnetic field to create coupling between resonator sections of the waveguides.

Moreover, E-plane waveguide filter 900 may provide a window coupling into an E-plane waveguide and/or coupling through a resonant mode TE₁₀₁ 950 to create a high-side transmission zero. According to some aspects, no resonant modes are created below a passband of the E-plane waveguide filter 900. According to some aspects, E-plane waveguide filter 900 may create a high-side or low-side transmission zero. RF filter design seeks to design a filter with a lowest passband loss and a highest rejection possible for a given filter specification. According to some aspects, a capability to create transmission zeros provides capability to improve out-of-band rejection, e.g., without adding resonator poles to the passband of the filter. This is an improvement to conventional filters because adding poles to a filter may increase out-of-band rejection, but also increases passband loss and higher passband loss degrades the signal power going through the filter.

According to some aspects, E-plane waveguide filter 900 may operate differently from E-plane waveguide filter 700. For example, E-plane waveguide 940 is formed by coupling third dielectric block 922 and fourth dielectric block 924, whereas a single block (e.g., third dielectric block 732) forms dual-mode rectangular waveguide 740. Moreover, E-plane waveguide 940 comprises an E-plane septum and windows, forming two E-plane resonators separated by a coupling septum that couples the two E-plane resonators of E-plane waveguide 940

As illustrated in FIG. 9B, four separate resonators of E-plane waveguide filter 900 may operate in a resonant mode TE₁₀₁ 950 at the center frequency of the filter. Unlike E-plane waveguide filter 700, for example, E-plane waveguide 940 does not operate in a dual mode. Rather, the respective locations of the two E-plane waveguides (e.g., respectively coupled third dielectric block 922 and fourth dielectric block 924) may create two RF paths capable of creating a transmission zero in the filter response. For example, when the IO's are at the ends of the 2-resonator E-plane cavity, the filter acts strictly as a 4-pole resonator filter.

As illustrated in FIG. 9C and FIG. 9D, as one E-plane waveguide block shifted towards the other, a bypass RF path is created that creates a transmission zero on the high-side of the passband. As illustrated in FIG. 9C, E-plane waveguide filter 900 does not have a resonant mode below the passband, because the E-plane waveguide 940 comprises two separate resonators and is not a “dual mode” resonator. As illustrated in FIG. 9D, when the E-plane waveguides (e.g., respectively coupled first dielectric blocks 910 and/or second dielectric blocks 930) are spaced farthest apart (e.g., as shown by increasing IO shifts in the insertion loss response 970), the filter response is a 4-pole filter as seen by 4 dips in the return loss response 960.

As illustrated by FIGS. 9E1 through 9E6, as one E-plane waveguide is moved towards the other E-plane waveguide, a bypass coupling path is created from RES2 to RES4. As illustrated by FIGS. 9E4 through 9E6, this creates a tri-circuit (e.g., coupling between RES2 and RES4) transmission zero on the high-side of the passband. As illustrated by FIGS. 9E7 through 9E9, when the 1st E-plane waveguide moves past the septum between RES2 and RES3, the circuit changes to a 3-pole filter (e.g., 3 dips in the return loss trace) and RES3 essentially becomes a 1-pole notch that creates a transmission zero on the low-side of the filter passband.

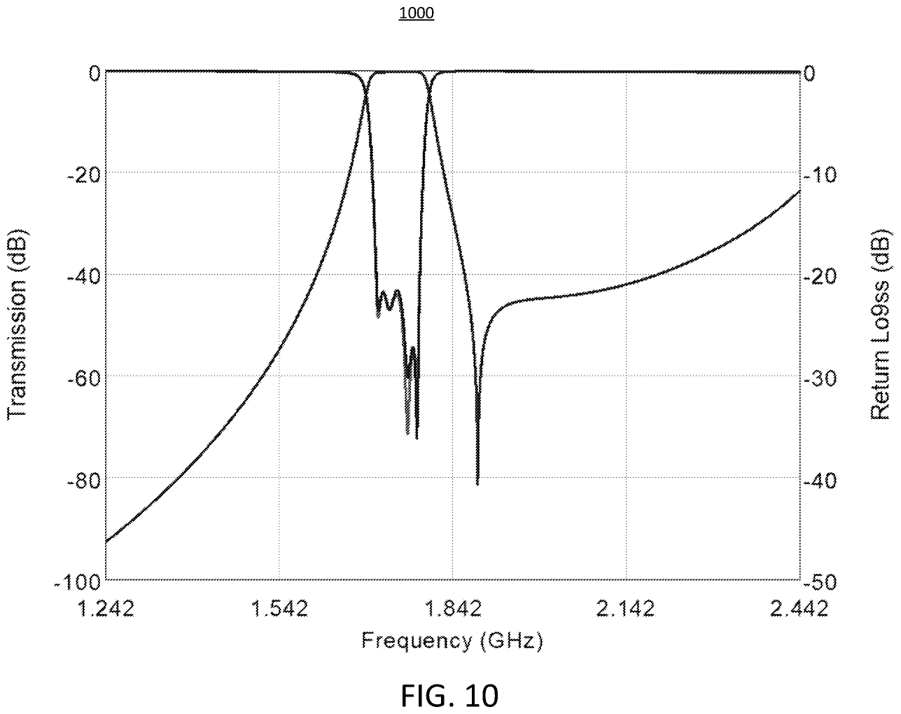

FIG. 10 depicts a frequency response graph 1000 for an E-plane waveguide filter (e.g., E-plane waveguide filter 900) according to the present disclosure. The frequency response graph 1000 may be associated with a performance of the E-plane waveguide filter 900 depicted in FIG. 9A, e.g., a configuration of a transmission zero for E-plane waveguide filter 900.

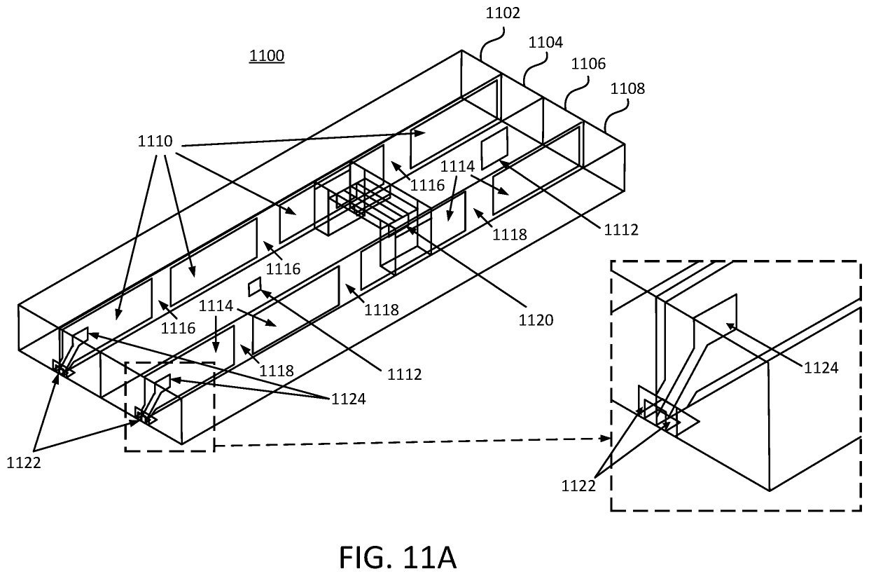

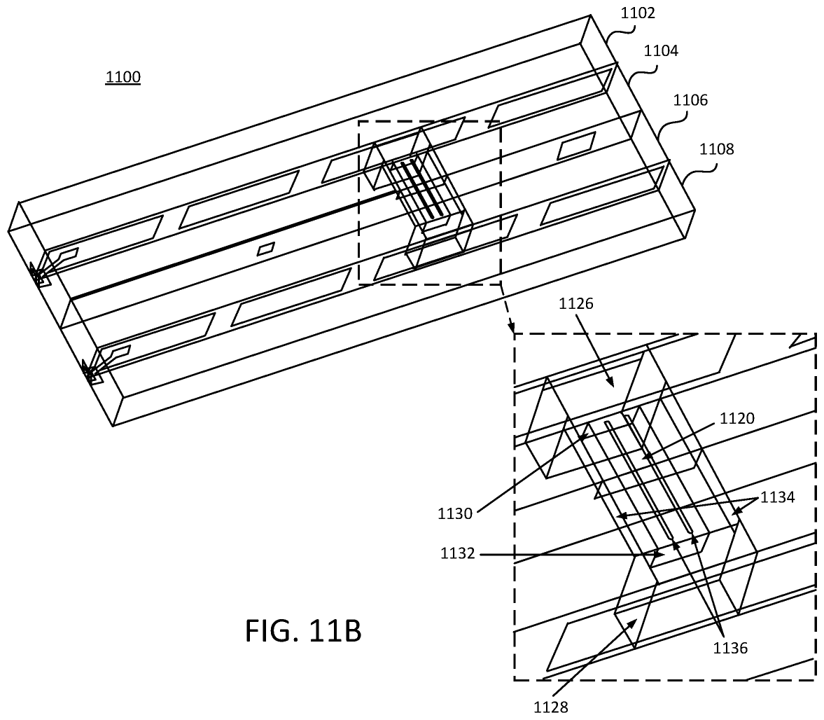

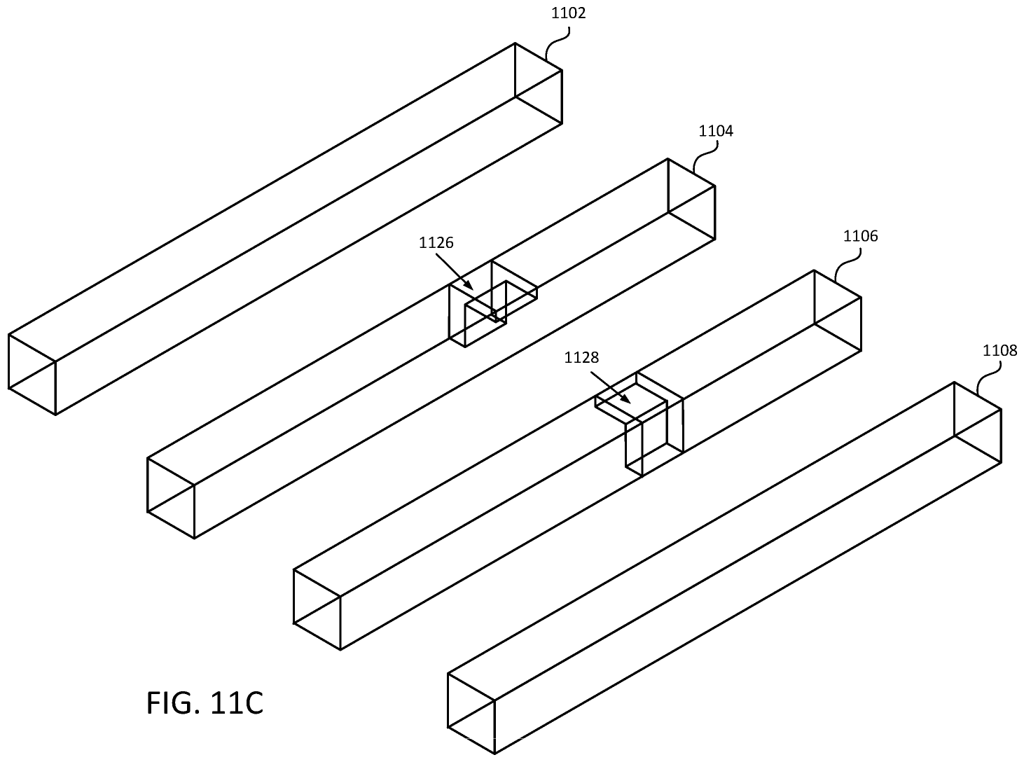

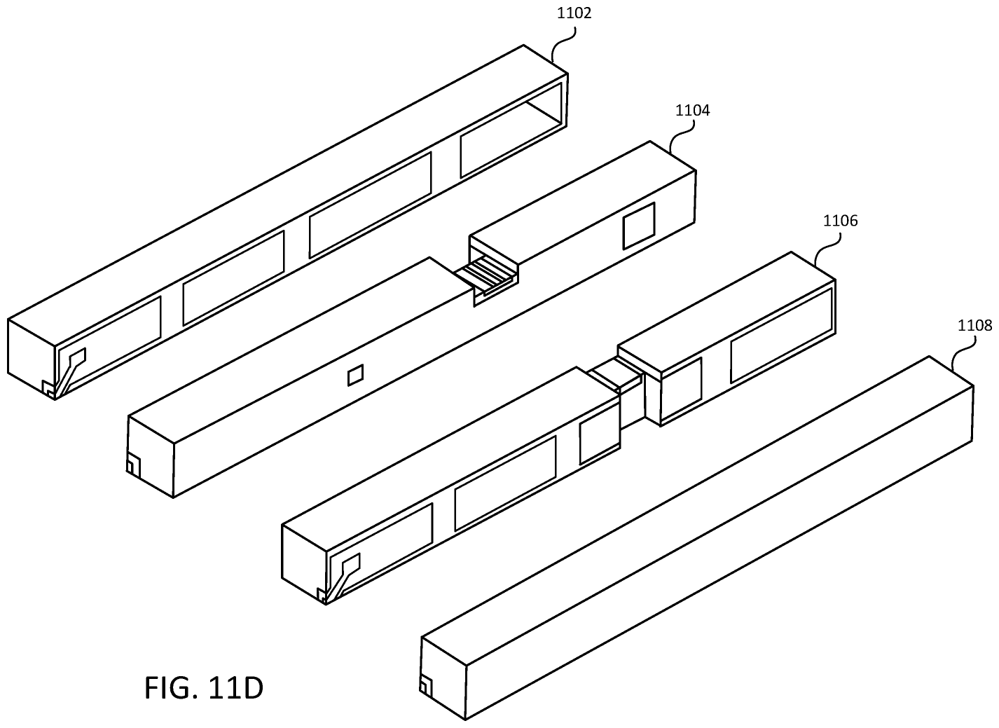

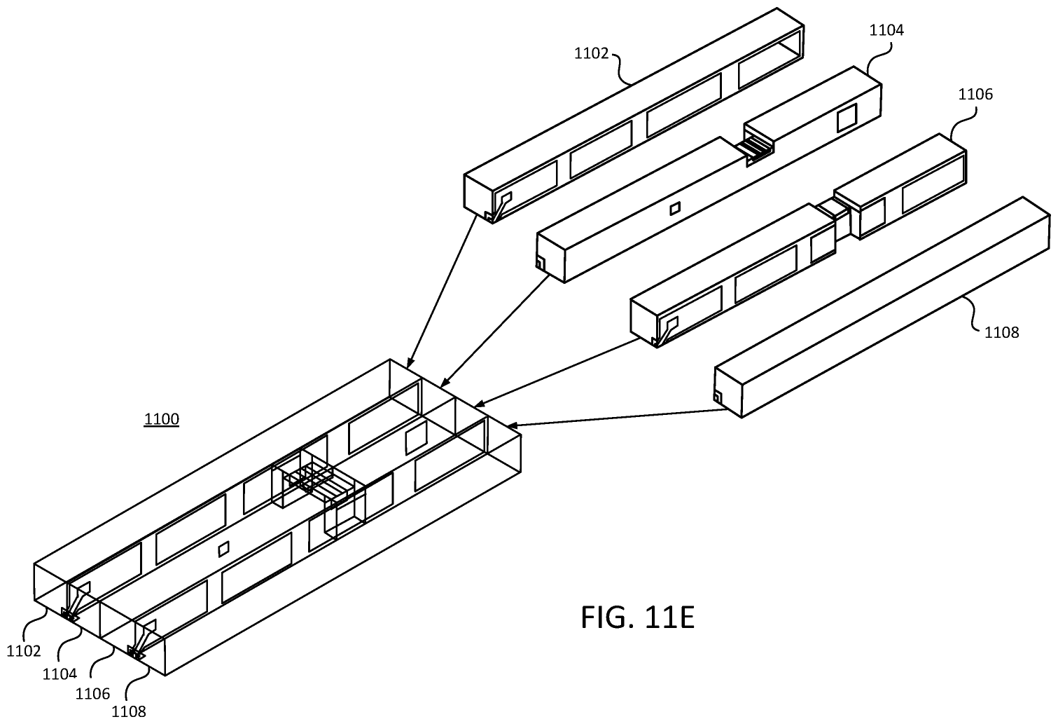

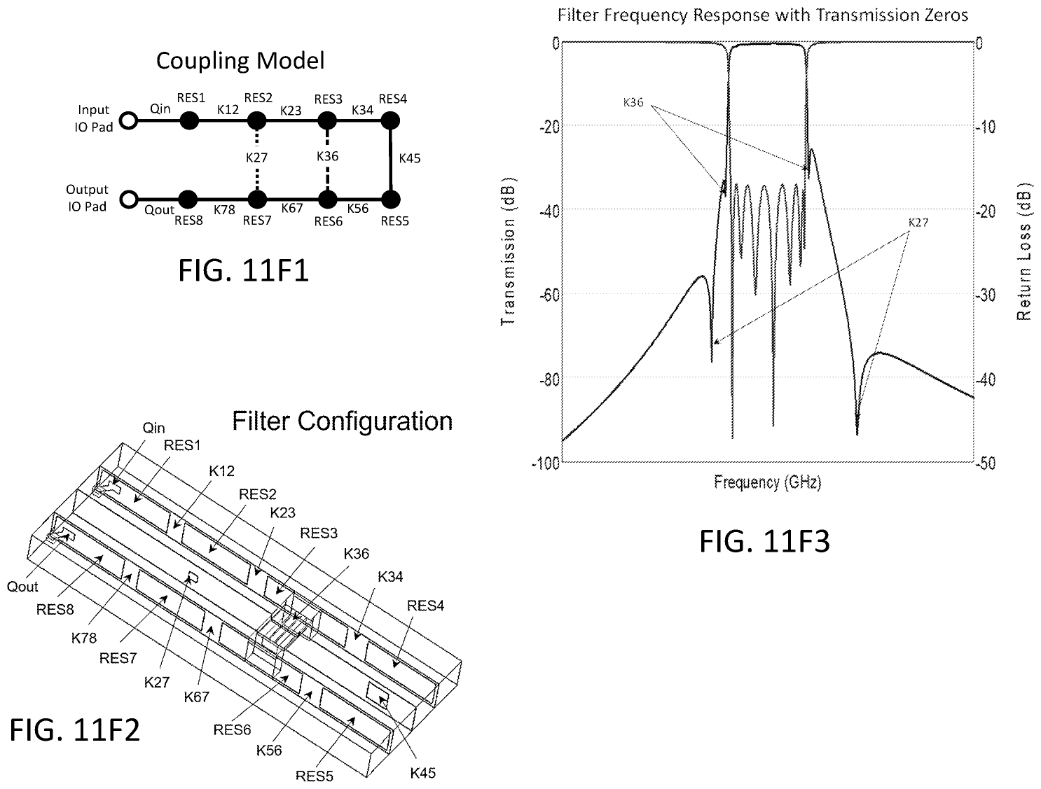

FIG. 11A depicts an E-plane waveguide filter 1100 according to the present disclosure. The E-plane waveguide filter 1100 may include a plurality of dielectric blocks. The E-plane waveguide filter 1100 may comprise first dielectric block 1102, second dielectric block 1104, third dielectric block 1106, and fourth dielectric block 1108. For example, one or more of the first dielectric block 1102, the second dielectric block 1104, the third dielectric block 1106, and the fourth dielectric block 1108 may be comprised of ceramic. Each of the first dielectric block 1102, the second dielectric block 1104, the third dielectric block 1106, and the fourth dielectric block 1108 may define one or more of length, width, and thickness dimensions. In some cases, one or more of the first dielectric block 1102, the second dielectric block 1104, the third dielectric block 1106, and the fourth dielectric block 1108 may be coated with a metallic substance. For example, the metallic substance may be formed on one or more outer surfaces of the first dielectric block 1102, the second dielectric block 1104, the third dielectric block 1106, and/or the fourth dielectric block 1108.

The first dielectric block 1102 may be coupled to the second dielectric block 1104 along respective longitudinal surfaces of the first dielectric block 1102 and the second dielectric block 1104. A surface of each block (e.g., first dielectric block 1102 and/or second dielectric block 1104) may comprise a metallic coating. For example, the first dielectric block 1102 and/or second dielectric block 1104 may be coated with a metallic substance prior to coupling to the other blocks of the E-plane waveguide filter 1100.

The second dielectric block 1104 may be coupled to the third dielectric block 1106 along respective longitudinal surfaces of the second dielectric block 1104 and the third dielectric block 1106. A surface of each block (e.g., second dielectric block 1104 and/or third dielectric block 1106) may comprise a metallic coating. For example, the second dielectric block 1104 and/or third dielectric block 1106 may be coated with a metallic substance prior to coupling to the other blocks of the E-plane waveguide filter 1100.

The third dielectric block 1106 may be coupled to the fourth dielectric block 1108 along respective longitudinal surfaces of the third dielectric block 1106 and the fourth dielectric block 1108. A surface of each block (e.g., third dielectric block 1106 and/or fourth dielectric block 1108) may comprise a metallic coating. For example, the third dielectric block 1106 and/or fourth dielectric block 1108 may be coated with a metallic substance prior to coupling to the other blocks of the E-plane waveguide filter 1100.

Various structures may be formed on one or more surfaces of the blocks (e.g., first dielectric block 1102, second dielectric block 1104, third dielectric block 1106, and/or fourth dielectric block 1108) of the E-plane waveguide filter 1100. For example, patterns (e.g., resonator windows, inductive windows, etc.) may be formed on the one or more surfaces by using lasers, plasma, or chemical processes to remove plating. In another example, additive processes (e.g., screen printing or metal ink printing) may be used to form patterns on the one or more surfaces. The patterns may be formed on one or more adjoining block surfaces to create various structures (e.g., resonator windows, inductive windows, etc.) of the E-plane waveguide filter 1100.

For example, first dielectric block 1102 may include a plurality (e.g., four) of resonator windows 1110. For example, one or more resonator windows 1110 (e.g., between adjacent blocks) may be formed on or through a surface of first dielectric block 1102 through additive processes (e.g., exposing portions of the block by adding a metallic material to other portions of the block) or by removing a metallic plating on a plated surface of the block (e.g., exposing portions of the block where the metallic plating is removed). The one or more resonator windows 1110 may expose a dielectric material within the first dielectric block 1102.

As another example, second dielectric block 1104 may include a plurality (e.g., two) of resonator windows 1112. For example, one or more resonator windows 1112 (e.g., between adjacent blocks) may be formed on or through a surface of second dielectric block 1104 through additive processes (e.g., exposing portions of the block by adding a metallic material to other portions of the block) or by removing a metallic plating on a plated surface of the block (e.g., exposing portions of the block where the metallic plating is removed). The one or more resonator windows 1112 may expose a dielectric material within the second dielectric block 1104.

As another example, third dielectric block 1108 may include a plurality (e.g., four) of resonator windows 1114. For example, one or more resonator windows 1112 (e.g., between adjacent blocks) may be formed on or through a surface of third dielectric block 1108 through additive processes (e.g., exposing portions of the block by adding a metallic material to other portions of the block) or by removing a metallic plating on a plated surface of the block (e.g., exposing portions of the block where the metallic plating is removed). The one or more resonator windows 1114 may expose a dielectric material within the third dielectric block 1108.

The one or more resonator windows 1110, one or more resonator windows 1112, and one or more resonator windows 1114 may be any size or shape, and may be an array of shapes and sizes. For example, each window of the one or more resonator windows 1110, one or more resonator windows 1112, and one or more resonator windows 1114 may be any planer geometric shape (e.g., rectangle, oval, polygonal, etc.). Moreover, each window of the one or more resonator windows 1110, one or more resonator windows 1112, and one or more resonator windows 1114 may be a different geometric shape relative to one or more of the other windows, and each window's height may be different. In some examples, a resonant frequency of the resonator may be determined by a length of the one or more resonator windows 1110, one or more resonator windows 1112, and one or more resonator windows 1114.

The one or more resonator windows 1110 may be separated (e.g., in the height dimension) by inter-resonator coupling septum or septa 1116. Each inter-resonator coupling septum 1116 may span the height of the window, and may run substantially parallel to a height dimension of a block. Moreover, the septa 1116 may be any shape and size, provided the septa 1116 disrupt the electric field to create a coupling between the one or more resonator windows 1110. For example, if the one or more resonator windows 1110 are oval shaped, the septa 1116 may be an hour-glass shape.

The one or more resonator windows 1114 may be separated (e.g., in the height dimension) by inter-resonator coupling septum or septa 1118. Each inter-resonator coupling septum 1118 may span the height of the window, and may run substantially parallel to a height dimension of a block. Moreover, the septa 1118 may be any shape and size, provided the septa 1118 disrupt the electric field to create a coupling between the one or more resonator windows 1114. For example, if the one or more resonator windows 1114 are oval shaped, the septa 1118 may be an hour-glass shape.

According to some aspects, the E-plane waveguide filter 1100 may comprise a capacitive cross coupling trace 1120. Moreover,, the E-plane waveguide filter 1100 may comprise a plurality of surface mount input/output (I/O) interfaces 1122, each of which may be in electrical connection with a capacitive I/O launch 1124. For example, one or more of the capacitive cross coupling trace 1120, surface mount input/output (I/O) interfaces 1122, and/or capacitive I/O launch 1124 may be formed by corresponding mating surfaces of the first dielectric block 1102, second dielectric block 1104, third dielectric block 1106, and/or fourth dielectric block 1108.

As illustrated in FIG. 11B, the capacitive cross coupling trace 1120 may be formed by corresponding features of adjacent dielectric blocks (e.g., second dielectric block 1104 and third dielectric block 1106). For example, second dielectric block 1104 may comprise a cross coupling groove 1126. Third dielectric block 1106 may comprise a cross coupling groove 1128 (e.g., corresponding to air cut groove 1126). Moreover, second dielectric block 1104 and third dielectric block 1106 may comprise corresponding folded sections (e.g., folded section 1130 and folded section 1132). Folded section 1128 and folded section 1130 may be sized to correspond to cross coupling trace 1120.

According to some aspects, cross coupling trace 1120 may comprise groove plating 1134. For example, groove plating 1134 may prevent any undesirable stray coupling. Cross coupling trace 1120 may further comprise a plurality of grooves 1136. For example, the grooves 1136 may be lased and may direct any repeated resonance associated with the cross coupling trace 1120 away from the passband.

FIG. 11C illustrates the dielectric blocks of E-plane waveguide filter 1100 prior to plating. For example, each of the first dielectric block 1102, the second dielectric block 1104, the third dielectric block 1106, and the fourth dielectric block 1108 may be comprised of a dielectric material, such as ceramic. Second dielectric block 1104 may comprise cross coupling groove 1126 and third dielectric block 1106 may comprise cross coupling groove 1128. Cross coupling groove 1126 may correspond to cross coupling groove 1128. For example, each of cross coupling groove 1126 and cross coupling groove 1128 may be air cut from the respective dielectric blocks. As another example, each of cross coupling groove 1126 and cross coupling groove 1128 may be lapped to size and ground into the respective dielectric blocks.

As illustrated in FIG. 11D, one or more surfaces of each of the dielectric blocks may be plated with a metallic coating. For example, the first dielectric block 1102, the second dielectric block 1104, the third dielectric block 1106, and the fourth dielectric block 1108 may be plated with silver. A plurality of patterns or features may be defined on one or more surfaces of the dielectric blocks. For example, the patterns or artwork may be defined by using a lasering process to remove the metallic coating.

As illustrated in FIG. 11E, the dielectric blocks may be assembled (e.g., through fire fusing, soldering or conductive epoxy) to form the E-plane waveguide filter 1100. For example, each of the first dielectric block 1102, the second dielectric block 1104, the third dielectric block 1106, and the fourth dielectric block 1108 may be assembled (e.g., after plating and lasing) to form the E-plane waveguide filter 1100. When coupled, the dielectric blocks may define resonator segments throughout the coupled blocks, where the characteristics of the resonator segments (e.g., resonant frequency, etc.) may be defined by the positioning, size, and shapes of the patterns or features (e.g., resonator windows, septa, capacitive I/O launches, or cross coupling traces).

FIG. 11F1 illustrates an E-plane waveguide filter (e.g., E-plane waveguide filter 1100). FIG. 11F2 illustrates a coupling model associated with the E-plane waveguide filter of FIG. 11F1. As illustrated in FIG. 11F2, bypass coupling paths may be created from RES2 to RES7 and RES3 to RES6. FIG. 11F3 illustrates a frequency response graph associated with the E-plane waveguide filter of FIG. 11F.

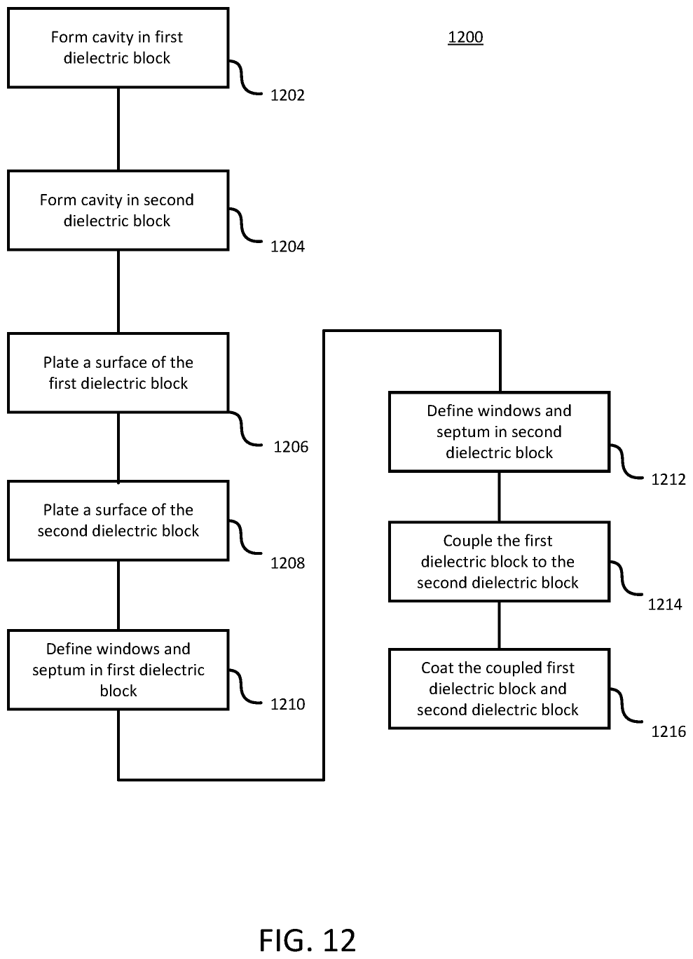

FIG. 12 depicts a process 1200 for manufacturing a filter according to the present disclosure. The filter may be an example of any one of the E-plane waveguide filters of FIG. 1-7 or 9. For example, E-plane waveguide filter 700 may include 5 blocks (e.g., each of which may be shaped and plated). In another example, E-plane waveguide filter 900 may include 6 blocks (e.g., each of which may be shaped and plated).

According to some aspects, conductive patterns may be created by additive plating. In an additive plating process a conductive coating may be placed on one or more parts of an E-plane waveguide filter (e.g., E-plane waveguide filter 700 or E-plane waveguide filter 900) in only the required locations. For example, a printer may print or spray conductive coatings only where needed (e.g., conducting coatings may not be applied where not needed). In an example additive plating process, a plurality of ceramic blocks of an E-plane waveguide filter may be mechanically shaped (e.g., by lapping, cutting, or grinding the one or more blocks), one or more surfaces of the blocks may be prepared for plating, the one or more surfaces may be plated using an additive plating process, the plating may be cured or fire plated, and the blocks may be connected together (e.g., forming an E-plane waveguide filter).

In an ablative plating process an entire part of an E-plane waveguide filter (e.g., E-plane waveguide filter 700 or E-plane waveguide filter 900) may be plated and areas where plating is not needed may be removed after plating. For example, the plating may be removed by photoetching and/or laser removal. In an example ablative process, a plurality of ceramic blocks of an E-plane waveguide filter may be mechanically shaped (e.g., by lapping, cutting, or grinding the one or more blocks), one or more surfaces of the blocks may be prepared for plating, plating may be added to the blocks, a masking coating may be added, plating may be selectively removed to form one or more E-plane structures, and the blocks may be connected together (e.g., forming an E-plane waveguide filter).

At step 1202, one or more recesses or cavities may be formed in a first dielectric block. For example, the one or more recesses or cavities may be formed on or in a longitudinal surface of the first dielectric block. The one or more recesses or cavities may form at least a part of one or more resonators. The first dielectric block may be an example of first dielectric block 110, first dielectric block 610, first dielectric block 710, and/or first dielectric block 910. A recess or cavity may span the width of the first dielectric block. Moreover, a width and a depth of the recess or cavity may vary. The recess or cavity may be generated, for example, by lasing the top (or other) surface of the first dielectric block. In other examples, the recess or cavity may be generated by one or more of metal printing, chemical etching and RF-sputtering and masking.

At step 1204, one or more recesses or cavities may be formed in a second dielectric block. The one or more recesses or cavities may form at least a part of one or more resonators. For example, the one or more recesses or cavities may be formed on or in a longitudinal surface of the second dielectric block. The second dielectric block may be an example of second dielectric block 130, second dielectric block 630, second dielectric block 730, and/or second dielectric block 930. A recess or cavity may span the width of the second dielectric block. Moreover, a width and a depth of the recess or cavity may vary. The recess or cavity may be generated, for example, by lasing the top (or other) surface of the second dielectric block.

At step 1206, a surface the first dielectric block may be plated. For example, a longitudinal surface of the first dielectric block (e.g., including one or more recesses or cavities) may be plated with a metallic coating.

At step 1208, a surface the second dielectric block may be plated. For example, a longitudinal surface of the second dielectric block (e.g., including one or more recesses or cavities) may be plated with a metallic coating.

At step 1210, windows and septum may be defined on a metalized surface of the first dielectric block. For example, one or more of resonators, a metalized septum for inter-resonator couplings, and/or various input and output couplings loops or probes for input loading into the filter may be pressed, machined, lased, or screen printed onto\into the blocks, e.g., eliminating the need for a separate septum. According to some aspects, the number, size, and shapes of the windows and septum can vary.

At step 1212, windows and septum may be defined on a metalized surface of the second dielectric block. For example, one or more of resonators, a metalized septum for inter-resonator couplings, and/or various input and output couplings loops or probes for input loading into the filter may be pressed, machined, lased, or screen printed onto\into the blocks, e.g., eliminating the need for a separate septum. According to some aspects, the number, size, and shapes of the windows and septum can vary.

At step 1214, an RF E-plane waveguide filter may be formed by coupling the first dielectric block to the second dielectric block. For example, a coupling structure associated with the first dielectric block may be attached to a coupling structure associated with the second dielectric block). A septum may be formed by the union of the first coupling structure and the second coupling structure. For example, the coupling may occur by positioning a respective longitudinal surface of the first dielectric block to be flush with a respective longitudinal surface of the second dielectric block. In some cases, the first dielectric block may be coupled to the second dielectric block \via adhesive, compression, and the like.

At step 1216, the coupled first dielectric block and the second dielectric block a dielectric blocks can be coated with a metallic coating. For example, the metallic coating may include one or more of silver, gold, indium, and copper, and may be sprayed onto the dielectric blocks, which can then be cured to solidify the coating.

While the figures herein describe particular examples of E-plane waveguide filters, one skilled in the art will understand that the E-plane waveguide filter described herein can vary based on particular dimensions and designs. For example, the number of windows included between dielectric blocks can vary, along with the particular size and shapes of the windows. Further, while the windows and septum are depicted on particular longitudinal surfaces, other longitudinal surfaces can also include windows and septum. For example, the windows and septum depicted on a particular surface may be additionally or alternatively be defined by the corresponding, adjacent surface of the corresponding, adjacent dielectric block. Similarly, the location of the input and output can vary as well, and can be placed in different positions along the surfaces of the filter. In some cases, additional dielectric blocks can be added to the filter as well, such that the filter contains six blocks, eight blocks, and the like.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed:

1. An E-plane waveguide filter comprising:
a first dielectric block comprising a first coupling structure;
a second dielectric block comprising a second coupling structure; and
a septum formed by a union of the first coupling structure and the second coupling structure.

2. The E-plane waveguide filter of claim 1, wherein the first coupling structure and the second coupling structure are pressed, machined, lased, or screen-printed.

3. The E-plane waveguide filter of claim 1, wherein
the first dielectric block comprises a first longitudinal surface comprising the first coupling structure, a second longitudinal surface, and a top surface, and
the second dielectric block comprises a first longitudinal surface comprising the second coupling structure, a second longitudinal surface, and a top surface, and is coupled to the first dielectric block via respective first longitudinal surfaces.

4. The E-plane waveguide filter of claim 1, further comprising a plurality of resonators defined by the first dielectric block and the second dielectric block.

5. The E-plane waveguide filter of claim 4, further comprising a metalized septum, wherein the plurality of resonators are coupled by the metalized septum.

6. The E-plane waveguide filter of claim 1, further comprising:
an input configured to receive a radio frequency signal and transfer the radio frequency signal to the union of the first coupling structure and the second coupling structure; and
an output configured to receive the radio frequency signal from the union of the first coupling structure and the second coupling structure.

7. The E-plane waveguide filter of claim 6, further comprising:
a first load loop configured to electrically couple the input to the union of the first coupling structure and the second coupling structure; and
a second load loop configured to electrically couple the output to the union of the first coupling structure and the second coupling structure.

8. An E-plane waveguide filter comprising:
a first dielectric block comprising a first coupling structure;
a second dielectric block comprising a second coupling structure;
a third dielectric block comprising a third coupling structure;
a fourth dielectric block comprising a fourth coupling structure;
a first septum formed by a union of the first coupling structure and the second coupling structure;
a second septum formed by a union of the third coupling structure and the fourth coupling structure; and
a dual-mode rectangular waveguide coupled to the first septum and the second septum.

9. The E-plane waveguide filter of claim 8, wherein the first coupling structure, the second coupling structure, the third coupling structure, and the fourth coupling structure are pressed, machined, lased, or screen-printed.

10. The E-plane waveguide filter of claim 8, wherein
the first dielectric block comprises a first longitudinal surface comprising the first coupling structure, a second longitudinal surface, and a top surface,
the second dielectric block comprises a first longitudinal surface comprising the second coupling structure, a second longitudinal surface, and a top surface, and is coupled to the first dielectric block via respective first longitudinal surfaces;
the third dielectric block comprises a first longitudinal surface comprising the third coupling structure, a second longitudinal surface, and a top surface; and
the fourth dielectric block comprises a first longitudinal surface comprising the fourth coupling structure, a second longitudinal surface, and a top surface, and is coupled to the third dielectric block via respective first longitudinal surfaces.

11. The E-plane waveguide filter of claim 8, further comprising a plurality of resonators defined by the first dielectric block, the second dielectric block, the third dielectric block, and the fourth dielectric block.

12. The E-plane waveguide filter of claim 11, further comprising a metalized septum, wherein the plurality of resonators are coupled by the metalized septum.

13. The E-plane waveguide filter of claim 8, further comprising:
an input configured to receive a radio frequency signal and transfer the radio frequency signal to the union of the first coupling structure and the second coupling structure; and
an output configured to receive the radio frequency signal from the union of the third coupling structure and the fourth coupling structure.

14. The E-plane waveguide filter of claim 13, further comprising:
a first load loop configured to electrically couple the input to the union of the first coupling structure and the second coupling structure; and
a second load loop configured to electrically couple the output to the union of the third coupling structure and the fourth coupling structure.

15. An E-plane waveguide filter comprising:
a first dielectric block comprising a first coupling structure;
a second dielectric block comprising a second coupling structure;
a third dielectric block comprising a third coupling structure;
a fourth dielectric block comprising a fourth coupling structure;
a fifth dielectric block comprising a fifth coupling structure;
a sixth dielectric block comprising a sixth coupling structure;
a first septum formed by a union of the first coupling structure and the second coupling structure;
a second septum formed by a union of the third coupling structure and the fourth coupling structure;
a third septum formed by a union of the fifth coupling structure and the sixth coupling structure; and
a rectangular waveguide coupled to the first septum and the second septum, wherein the rectangular waveguide comprises the third septum.

16. The E-plane waveguide filter of claim 15, wherein the first coupling structure, the second coupling structure, the third coupling structure, the fourth coupling structure, the fifth coupling structure, and the sixth coupling structure are pressed, machined, lased, or screen-printed.

17. The E-plane waveguide filter of claim 15, wherein
the first dielectric block comprises a first longitudinal surface comprising the first coupling structure, a second longitudinal surface, and a top surface,
the second dielectric block comprises a first longitudinal surface comprising the second coupling structure, a second longitudinal surface, and a top surface, and is coupled to the first dielectric block via respective first longitudinal surfaces;
the third dielectric block comprises a first longitudinal surface comprising the third coupling structure, a second longitudinal surface, and a top surface;
the fourth dielectric block comprises a first longitudinal surface comprising the fourth coupling structure, a second longitudinal surface, and a top surface, and is coupled to the third dielectric block via respective first longitudinal surfaces;
the fifth dielectric block comprises a first longitudinal surface comprising the fifth coupling structure, a second longitudinal surface, and a top surface; and
the sixth dielectric block comprises a first longitudinal surface comprising the sixth coupling structure, a second longitudinal surface, and a top surface, and is coupled to the fifth dielectric block via respective first longitudinal surfaces.

18. The E-plane waveguide filter of claim 15, further comprising a plurality of resonators defined by the first dielectric block, the second dielectric block, the third dielectric block, the fourth dielectric block, the fifth dielectric block, and the sixth dielectric block.

19. The E-plane waveguide filter of claim 18, further comprising a metalized septum, wherein the plurality of resonators are coupled by the metalized septum.

20. The E-plane waveguide filter of claim 15, further comprising:
an input configured to receive a radio frequency signal and transfer the radio frequency signal to the union of the first coupling structure and the second coupling structure; and
an output configured to receive the radio frequency signal from the union of the third coupling structure and the fourth coupling structure.
